(19) United States
(12) Patent Application Publication
(10) Pub. No.: US 2018/0095208 A1
(43) Pub. Date: Apr. 5, 2018

(54) SOLAR CONTROL WINDOW FILM

(71) Applicant: SAINT-GOBAIN PERFORMANCE PLASTICS CORPORATION, Solon, OH (US)

(72) Inventors: Antoine DIGUET, Paris (FR); Virginie MOREAU, Compiegne (FR)

(21) Appl. No.: 15/715,346

(22) Filed: Sep. 26, 2017

Related U.S. Application Data
(60) Provisional application No. 62/403,314, filed on Oct. 3, 2016.

(51) Int. Cl. G02B 5/28; G02B 5/08

(52) U.S. Cl. CPC G02B 5/282; G02B 5/0875

(57) ABSTRACT

A composite film may include a first transparent substrate, a dielectric layer and at least two infra-red reflection stacks. The dielectric layer may be located between the at least two infra-red reflection stacks and each of the infra-red reflection stacks may include two blocker layers and a functional layer. The blocker layers in each infra-red reflection stack may each include NiCr. The functional layer in each infra-red reflection stack may include silver and may be located between the two blocker layers.

### CROSS-REFERENCE TO RELATED APPLICATION

This Application claims priority under 35 U.S.C. § 119(e) to U.S. Provisional Patent Application No. 62/403,314, entitled “SOLAR CONTROL WINDOW FILM,” by Antoine Diguet et al., filed Oct. 3, 2016, which is assigned to the current assignee hereof and is incorporated herein by reference in its entirety.

### FIELD OF THE DISCLOSURE

The present disclosure relates to a solar control window film. In particular, the present disclosure relates to a solar control window film having particular solar energy characteristics that may be configured for use on an automobile window or an automobile sunroof.

### BACKGROUND

Composite window films can be used as coverings applied to windows in building or vehicles to control the passage of solar radiation through transmission, reflection, and absorption. For certain composite window films, visible light transmittance and reflectance must be low and the total solar energy rejection must be high. This combination of features is of great importance for particular systems. As such, a need exists for composite window films which have superior combined visible light transmittance, visible light reflectance, and total solar energy rejection properties at the desired levels.

### SUMMARY

According to a first aspect, a composite film may include a first transparent substrate, a dielectric layer and at least two infra-red reflection stacks. The dielectric layer may be located between the at least two infra-red reflection stacks and each of the infra-red reflection stacks may include two blocker layers and a functional layer. The blocker layers in each infra-red reflection stack may each include NiCr. The functional layer in each infra-red reflection stack may include silver and may be located between the two blocker layers.

According to still another aspect, a composite film may include a first transparent substrate, a first dielectric layer located adjacent to the first transparent substrate layer, a first blocker layer that may include NiCr and may be located adjacent to the first dielectric layer, a first functional layer that may include silver and may be located adjacent to the first blocker layer, a second blocker layer that may include NiCr and may be located adjacent to the first functional layer, a second dielectric layer that may be located adjacent to the second blocker layer, a third blocker layer that may include NiCr and may be located adjacent to the second dielectric layer, a second functional layer that may include silver and may be located adjacent to the third blocker layer, a fourth blocker layer that may include NiCr and may be located adjacent to the second functional layer, a third dielectric layer that may be located adjacent to the fourth blocker layer, and a second transparent substrate overlying the third dielectric layer.

According to still another aspect, a method of forming a composite film may include providing a first transparent substrate, forming a first blocker layer that may include NiCr and may be located adjacent to the first dielectric layer, forming a first functional layer that may include silver and may be located adjacent to the first blocker layer, forming a second blocker layer that may include NiCr and may be located adjacent to the first functional layer, forming a second dielectric layer that may be located adjacent to the second blocker layer, forming a third blocker layer that may include NiCr and may be located adjacent to the second dielectric layer, forming a second functional layer that may include silver and may be located adjacent to the third blocker layer, forming a fourth blocker layer that may include NiCr and may be located adjacent to the second functional layer, forming a third dielectric layer that may be located adjacent to the fourth blocker layer, and forming a second transparent substrate overlying the third dielectric layer.

According to yet another aspect, a composite window film may include a first transparent substrate, a dielectric layer and at least two infra-red reflection stacks. The dielectric layer may be located between the at least two infra-red reflection stacks and each of the infra-red reflection stacks may include two blocker layers and a functional layer. The blocker layers in each infra-red reflection stack may each include NiCr and may each have a thickness of at least about 0.2 nm and not greater than about 5 nm. The functional layer in each infra-red reflection stack may include silver and may be located between the two blocker layers.

According to still another aspect, a composite window film may include a first transparent substrate, a first dielectric layer located adjacent to the first transparent substrate layer, a first blocker layer that may include NiCr and may be located adjacent to the first dielectric layer, a first functional layer that may include silver and may be located adjacent to the first blocker layer, a second blocker layer that may include NiCr and may be located adjacent to the first functional layer, a second dielectric layer that may be located adjacent to the second blocker layer, a third blocker layer that may include NiCr and may be located adjacent to the second dielectric layer, a second functional layer that may include silver and may be located adjacent to the third blocker layer, a fourth blocker layer that may include NiCr and may be located adjacent to the second functional layer, a third dielectric layer that may be located adjacent to the fourth blocker layer, and a second transparent substrate overlying the third dielectric layer. The blocker layers may each have a thickness of at least about 0.2 nm and not greater than about 5 nm.

According to still another aspect, a method of forming a composite window film may include providing a first transparent substrate, forming a first blocker layer that may include NiCr and may be located adjacent to the first dielectric layer, forming a first functional layer that may include silver and may be located adjacent to the first blocker layer, forming a second blocker layer that may include NiCr and may be located adjacent to the first functional layer, forming a second dielectric layer that may be located adjacent to the second blocker layer, forming a third blocker layer that may include NiCr and may be located adjacent to the second dielectric layer, forming a second functional layer that may include silver and may be located adjacent to the third blocker layer, forming a fourth blocker layer that may include NiCr and may be located adjacent to the second functional layer, forming a third dielectric layer that may be located adjacent to the fourth blocker layer, and forming a second transparent substrate overlying the third dielectric layer. The blocker layers may each have a thickness of at least about 0.2 nm and not greater than about 5 nm.

According to yet another aspect, a composite window film configured for application on a sunroof may include a first transparent substrate, a dielectric layer and at least two infra-red reflection stacks. The dielectric layer may be located between the at least two infra-red reflection stacks and each of the infra-red reflection stacks may include two blocker layers and a functional layer. The blocker layers in each infra-red reflection stack may each include NiCr and may each have a thickness of at least about 1 nm and not greater than about 5 nm. The functional layer in each infra-red reflection stack may include silver and may be located between the two blocker layers.

According to still another aspect, a composite window film configured for application on a sunroof may include a first transparent substrate, a first dielectric layer located adjacent to the first transparent substrate layer, a first blocker layer that may include NiCr and be located adjacent to the first dielectric layer, a first functional layer that may include silver and be located adjacent to the first blocker layer, a second blocker layer that may include NiCr and be located adjacent to the first functional layer, a second dielectric layer that may be located adjacent to the second blocker layer, a third blocker layer that may include NiCr and may be located adjacent to the second dielectric layer, a second functional layer that may include silver and may be located adjacent to the third blocker layer; a fourth blocker layer that may include NiCr and may be located adjacent to the second functional layer, a third dielectric layer that may be located adjacent to the fourth blocker layer, and a second transparent substrate overlying the third dielectric layer. The blocker layers may each have a thickness of at least about 1 nm and not greater than about 5 nm.

According to still another aspect, a method of forming a composite window film configured for application on a sunroof may include providing a first transparent substrate, forming a first blocker layer that may include NiCr and may be located adjacent to the first dielectric layer, forming a first functional layer that may include silver and may be located adjacent to the first blocker layer, forming a second blocker layer that may include NiCr and may be located adjacent to the first functional layer, forming a second dielectric layer that may be located adjacent to the second blocker layer, forming a third blocker layer that may include NiCr and may be located adjacent to the second dielectric layer, forming a second functional layer that may include silver and may be located adjacent to the third blocker layer; forming a fourth blocker layer that may include NiCr and may be located adjacent to the second functional layer, forming a third dielectric layer that may be located adjacent to the fourth blocker layer, and forming a second transparent substrate overlying the third dielectric layer. The blocker layers may each have a thickness of at least about 1 nm and not greater than about 5 nm.

### BRIEF DESCRIPTION OF THE DRAWINGS

Embodiments are illustrated by way of example and are not limited in the accompanying figures.

FIG. 1 includes an illustration of an example composite window film according to certain embodiments described herein;

FIG. 2 includes an illustration of another example composite window film according to certain embodiments described herein;

FIG. 3 includes an illustration of another example composite window film according to certain embodiments described herein

FIG. 4 includes an illustration of another example composite window film according to certain embodiments described herein;

FIG. 5 includes an illustration of another example composite window film according to certain embodiments described herein;

FIG. 6 includes an illustration of another example composite window film according to certain embodiments described herein;

FIG. 7 includes an illustration of another example composite window film according to certain embodiments described herein;

FIG. 8 includes an illustration of another example composite window film according to certain embodiments described herein;

FIG. 9 includes an illustration of another example composite window film according to certain embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. Further, the use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

As used herein, the term “visible light transmittance” or “VLT” refers to the ratio of total light visible to the human eye (i.e., having a wavelength between 380 nm and 780 nanometers) that is transmitted through a composite stack/transparent substrate system and may be calculated using a D65 light source at a 10° angle.

The term “total solar energy rejected” or “TSER” refers to the total solar energy (heat) that is not transferred through the composite stack/transparent substrate system and may be calculated according to the equation TSER=1-g, where g is equal to the total solar energy transmittance as defined by ISO 9050.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control arts.

Embodiments described herein are generally directed to composite films that include a multi-layer structure having at least one first transparent substrate, a dielectric layer and at least two infra-red reflection stacks. The dielectric layer may be located between the at least two infra-red reflection stacks. Each infra-red reflection stack may include two blocker layers and a functional layer that may be located between the two blocker layers. Each of the blocker layers may include NiCr and the functional layer may include silver. The composite film formed according to embodiments described herein may have particular performance characteristics, such as, high visible light transmittance, high TSER or a combination of thereof.

These concepts are better understood in view of the embodiments described below that illustrate and do not limit the scope of the present disclosure.

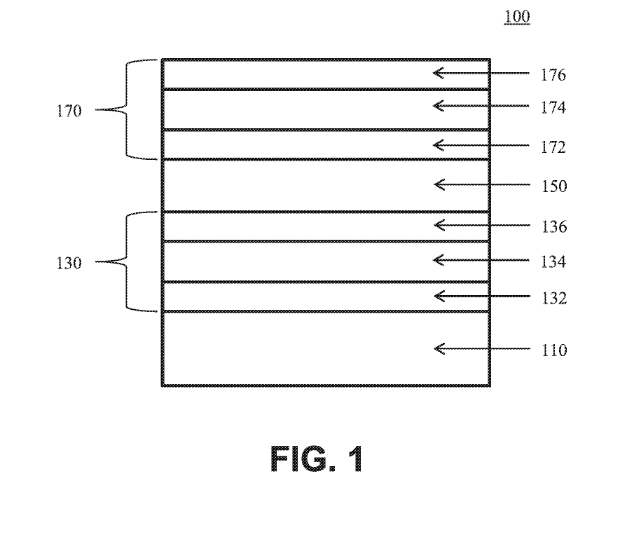

FIG. 1 includes an illustration of a cross-sectional view of a portion of an example composite film 100. As shown in FIG. 1, the composite film 100 may include a first transparent substrate 110, a first infra-red reflection stack 130, a second infra-red reflection stack 170 and a first dielectric layer 150 located between that first infra-red reflection stack 130 and the second infra-red reflection stack 170. The first infra-red reflection stack 130 may include a first blocker layer 132, the second blocker layer 136 and a first functional layer 134. The first blocker layer 132 may include NiCr. The second blocker layer 136 may include NiCr. The first functional layer 134 may include silver. The second infra-red reflection stack 170 may include a third blocker layer 172, a fourth blocker layer 176 and a second functional layer 174. The third blocker layer 172 may include NiCr. The fourth blocker layer 176 may include NiCr. The second functional layer 174 may include silver.

According to particular embodiments, the first transparent substrate 110 may include a polymer material. According to another particular embodiment, the first transparent substrate 110 may consist of a polymer material. According to still other embodiments, the first transparent substrate 110 may be a polymer substrate layer. According to particular embodiments, the polymer substrate layer may include any desirable polymer material.

According to still other embodiments, the first transparent substrate 110 may include a polyethylene terephthalate (PET) material. According to another particular embodiment, the first transparent substrate 110 may consist of a PET material. According to still other embodiments, the first transparent substrate 110 may be a PET substrate layer. According to particular embodiments, the PET substrate layer may include any desirable polymer material.

According to yet another embodiment, the first transparent substrate 110 may include a glass material. According to yet another embodiment, the first transparent substrate 110 may consist of a glass material. According to still another embodiment, the first transparent substrate 110 may be a glass substrate layer. According to still other embodiments, the glass material may include any desirable glass material.

According to still other embodiments, when the first transparent substrate 110 is a polymer substrate layer, it may have a particular thickness. For example, the first transparent substrate 110 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the first transparent substrate 110 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that the first transparent substrate 110 may have a thickness within a range between any of minimum and maximum values noted above. It will be further appreciated that the first transparent substrate 110 may have a thickness of any value between any of the minimum and maximum values noted above.

It will be further appreciated that when the first transparent substrate 110 is a glass substrate layer, it may have any desired thickness.

According to particular embodiments, the first functional layer 134 may include silver. According to yet another embodiment, the first functional layer 134 may consist essentially of silver. According to still another embodiment, the first functional layer 134 may be a silver layer.

According to still other embodiments, the first functional layer 134 may have a particular thickness. For example, the first functional layer 134 may have a thickness of at least about 5 nanometers, such as, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers, at least about 20 nanometers, at least about 25 nanometers, at least about 30 nanometers or even at least about 35 nanometers. According to still another embodiment, the first functional layer 134 may have a thickness of not greater than about 40 nanometers, such as, not greater than about 39 nanometers, not greater than about 38 nanometers, not greater than about 37 nanometers, not greater than about 36 nanometers, not greater than about 35 nanometers, not greater than about 34 nanometers, not greater than about 33 nanometers, not greater than about 32 nanometers or even not greater than about 31 nanometers. It will be appreciated that the first functional layer 134 may have a thickness within a range between any of minimum and maximum values noted above. It will be further appreciated that first functional layer 134 may have a thickness of any value between any of the minimum and maximum values noted above.

According to another embodiment, the first blocker layer 132 may include NiCr. According to still another embodiment, the first blocker layer 132 may consist essentially of NiCr. According to yet another embodiment, the first blocker layer 132 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the first blocker layer 132 may have a particular thickness. For example, the first blocker layer 132 may have a thickness of not greater than about 10 nanometers, such as, not greater than about 9 nanometers, not greater than about 8 nanometers, not greater than about 7 nanometers, not greater than about 6 nanometers, not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the first blocker layer 132 may have a thickness of at least about 0.1 nanometers, such as, at least about 0.2 nanometers, at least about 0.3 nanometers, at least about 0.4 nanometers. It will be appreciated that the first blocker layer 132 may have a thickness within a range between any of minimum and maximum values noted above. It will be further appreciated the first blocker layer 132 may have a thickness of any value between any of the minimum and maximum values noted above.

According to another embodiment, the second blocker layer 136 may include NiCr. According to still another embodiment, the second blocker layer 136 may consist essentially of NiCr. According to yet another embodiment, the second blocker layer 136 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the second blocker layer 136 may have a particular thickness. For example, the second blocker layer 136 may have a thickness of not greater than about 10 nanometers, such as, not greater than about 9 nanometers, not greater than about 8 nanometers, not greater than about 7 nanometers, not greater than about 6 nanometers, not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the second blocker layer 136 may have a thickness of at least about 0.1 nanometers, such as, at least about 0.2 nanometers, at least about 0.3 nanometers, at least about 0.4 nanometers. It will be appreciated that the second blocker layer 136 may have a thickness within a range between any of minimum and maximum values noted above. It will be further appreciated that the second blocker layer 136 may have a thickness of any value between any of the minimum and maximum values noted above.

According to particular embodiments, the second functional layer 174 may include silver. According to yet another embodiment, the second functional layer 174 may consist essentially of silver. According to still another embodiment, the second functional layer 174 may be a silver layer.

According to still other embodiments, the second functional layer 174 may have a particular thickness. For example, the second functional layer 174 may have a thickness of at least about 5 nanometers, such as, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers, at least about 20 nanometers, at least about 25 nanometers, at least about 30 nanometers or even at least about 35 nanometers. According to still another embodiment, the second functional layer 174 may have a thickness of not greater than about 40 nanometers, such as, not greater than about 39 nanometers, not greater than about 38 nanometers, not greater than about 37 nanometers, not greater than about 36 nanometers, not greater than about 35 nanometers, not greater than about 34 nanometers, not greater than about 33 nanometers, not greater than about 32 nanometers or even not greater than about 31 nanometers. It will be appreciated that the second functional layer 174 may have a thickness within a range between any of minimum and maximum values noted above. It will be further appreciated that second functional layer 174 may have a thickness of any value between any of the minimum and maximum values noted above.

According to another embodiment, the third blocker layer 172 may include NiCr. According to still another embodiment, the third blocker layer 172 may consist essentially of NiCr. According to yet another embodiment, the third blocker layer 172 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the third blocker layer 172 may have a particular thickness. For example, the third blocker layer 172 may have a thickness of not greater than about 10 nanometers, such as, not greater than about 9 nanometers, not greater than about 8 nanometers, not greater than about 7 nanometers, not greater than about 6 nanometers, not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the third blocker layer 172 may have a thickness of at least about 0.1 nanometers, such as, at least about 0.2 nanometers, at least about 0.3 nanometers, at least about 0.4 nanometers. It will be appreciated that the third blocker layer 172 may have a thickness within a range between any of minimum and maximum values noted above. It will be further appreciated the third blocker layer 172 may have a thickness of any value between any of the minimum and maximum values noted above.

According to another embodiment, the fourth blocker layer 176 may include NiCr. According to still another embodiment, the fourth blocker layer 176 may consist essentially of NiCr. According to yet another embodiment, the fourth blocker layer 176 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the fourth blocker layer 176 may have a particular thickness. For example, the fourth blocker layer 176 may have a thickness of not greater than about 10 nanometers, such as, not greater than about 9 nanometers, not greater than about 8 nanometers, not greater than about 7 nanometers, not greater than about 6 nanometers, not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the fourth blocker layer 176 may have a thickness of at least about 0.1 nanometers, such as, at least about 0.2 nanometers, at least about 0.3 nanometers, at least about 0.4 nanometers. It will be appreciated that the fourth blocker layer 176 may have a thickness within a range between any of minimum and maximum values noted above. It will be further appreciated that the fourth blocker layer 176 may have a thickness of any value between any of the minimum and maximum values.

According to certain embodiments, the first dielectric layer 150 may include a dielectric material. According to still other embodiments, the first dielectric layer 150 may consist essentially of a dielectric material. The dielectric material of the first dielectric layer 150 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the first dielectric layer 150 may include any one of ITO, SnZnOₓ, SiOₓ, Si₃N₄, Nb₂Oₓ, TiOₓ, In₂Oₓ, ZnOₓ or AZO. According to still other embodiments, the first dielectric layer 150 may consist essentially of any one of ITO, SnZnOₓ, SiOₓ, Si₃N₄, Nb₂Oₓ, TiOₓ, In₂Oₓ, ZnOₓ or AZO

According to yet another embodiment, the first dielectric layer 150 may have a particular thickness. For example, the first dielectric layer 150 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the first dielectric layer 150 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the first dielectric layer 150 may have a thickness within a range between any of minimum and maximum values noted above. It will be further appreciated that the first dielectric layer 150 may have a thickness of any value between any of the minimum and maximum values noted above.

It will be appreciated that the first dielectric layer 150 may include multiple dielectric layers. It will be further appreciated that any dielectric layer making up the first dielectric layer 150 may have any of the characteristics described herein in reference to the first dielectric layer 150.

According to yet another embodiment, the composite film 100 may have a particular thickness ratio TH_{BL1}/TH_{FL1}, where TH_{BL1} is the thickness of the first blocker layer 132 and TH_{FL1} is the thickness of the first functional layer 134. For example, the composite film 100 may have a ratio TH_{BL1}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite film 100 may have a ratio TH_{BL1}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite film 100 may have a ratio TH_{BL1}/TH_{FL1} of any value within a range between any of minimum and maximum values noted above. It will be further appreciated that the composite film 100 may have a ratio TH_{BL1}/TH_{FL1} of any value between any of the minimum and maximum values noted above.

According to yet another embodiment, the composite film 100 may have a particular thickness ratio TH_{BL2}/TH_{FL1}, where TH_{BL2} is the thickness of the second blocker layer 136 and TH_{FL1} is the thickness of the first functional layer 134. For example, the composite film 100 may have a ratio TH_{BL2}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite film 100 may have a ratio TH_{BL2}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite film 100 may have a ratio TH_{BL2}/TH_{FL1} of any value within a range between any of minimum and maximum values noted above. It will be further appreciated that the composite film 100 may have a ratio TH_{BL2}/TH_{FL1} of any value between any of the minimum and maximum values noted above.

According to yet another embodiment, the composite film 100 may have a particular thickness ratio TH_{BL3}/TH_{FL2}, where TH_{BL3} is the thickness of the third blocker layer 172 and TH_{FL2} is the thickness of the second functional layer 174. For example, the composite film 100 may have a ratio TH_{BL3}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite film 100 may have a ratio TH_{BL3}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite film 100 may have a ratio TH_{BL3}/TH_{FL2} of any value within a range between any of minimum and maximum values noted above. It will be further appreciated that the composite film 100 may have a ratio TH_{BL3}/TH_{FL2} of any value between any of the minimum and maximum values noted above.

According to yet another embodiment, the composite film 100 may have a particular thickness ratio TH_{BL4}/TH_{FL2}, where TH_{BL4} is the thickness of the fourth blocker layer 176 and TH_{FL2} is the thickness of the second functional layer 174. For example, the composite film 100 may have a ratio TH_{BL4}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite film 100 may have a ratio TH_{BL4}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite film 100 may have a ratio TH_{BL4}/TH_{FL2} of any value within a range between any of minimum and maximum values noted above. It will be further appreciated that the composite film 100 may have a ratio TH_{BL4}/TH_{FL2} of any value between any of the minimum and maximum values noted above.

According to yet other embodiments, the composite film 100 may have a particular VLT. For example, the composite stack 100 may have a VLT of at least about 10%, at least about 15%, at least about 20%, at leas about 25%, at least about 30%, at least about 35%, at least about 40%, at least about 45%, at least about 50%, at least about 55%, at least about 60%, at least about 65%, at least about 70%, at least about 75%, at least about 80%, at least about 85% at least about 85% or even at least about 90%. According to still another embodiment, the composite film 100 may have a VLT of not greater than about 99%. It will be appreciated that the composite film 100 may have a VLT within a range between any of minimum and maximum values noted above. It will be further appreciated that the composite film 100 have a VLT of any value between any of the minimum and maximum values noted above.

According to still another embodiment, the composite film 100 may have a particular TSER. For example, the composite film 100 may have a TSER of at least about 40%, such as, at least about 45%, at least about 50%, at least about 55%, at least about 60%, at least about 65% or even at least about 70%. According to yet other embodiments, the composite film 100 may have a TSER of not greater than about 85%, such as, not greater than about 80%, not greater than about 75% or even not greater than about 70%. It will be appreciated that the composite film 100 may have a TSER within a range between any of minimum and maximum values noted above. It will be further appreciated that the composite film 100 may have a TSER of any value between any of the minimum and maximum values noted above.

According to yet other embodiments, the composite film 100 may have a particular Solar Control Ratio VLT/(100%-TSER). For example, the composite film 100 may have a Solar Control Ratio of at least about 0.5, such as, at least about 0.6, at least about 0.7, at least about 0.8, at least about 0.9, at least about 1.0, at least about 1.1, at least about 1.2, at least about 1.3, at least about 1.4 or even at least about 1.5. According to still other embodiments, the composite film 100 may have a Solar Control Ratio of not greater than about 2.0, such as, not greater than about 1.9, not greater than about 1.8, not greater than about 1.7 or even not greater than about 1.6. It will be appreciated that the composite film 100 may have a Solar Control Ratio within a range between any of minimum and maximum values noted above. It will be further appreciated that the composite film 100 may have a Solar Control Ratio of any value between any of the minimum and maximum values noted above.

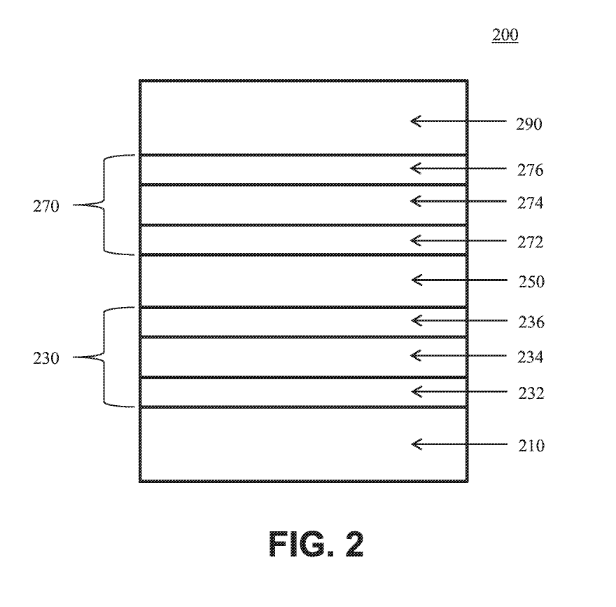

FIG. 2 includes an illustration of a cross-sectional view of a portion of another example composite film 200. As shown in FIG. 2, the composite film 200 may include a first transparent substrate 210, a first infra-red reflection stack 230, a second infra-red reflection stack 270, a first dielectric layer 250 located between that first infra-red reflection stack 230 and the second infra-red reflection stack 270 and a second transparent substrate 290 located within the film so that the first infra-red reflection stack 230, the second infra-red reflection stack 270 and the first dielectric layer 250 are all located between the first transparent substrate 210 and the second transparent substrate 290. The first infra-red reflection stack 230 may include a first blocker layer 232, the second blocker layer 236 and a first functional layer 234. The first blocker layer 232 may include NiCr. The second blocker layer 236 may include NiCr. The first functional layer 234 may include silver. The second infra-red reflection stack 270 may include a third blocker layer 272, a fourth blocker layer 276 and a second functional layer 274. The third blocker layer 272 may include NiCr. The second blocker layer 276 may include NiCr. The second functional layer 274 may include silver.

It will be appreciated that the composite film 200 and all layers described in reference to the composite film 200 may have any of the characteristics described herein with reference to corresponding layers in FIG. 1.

According to particular embodiments, the second transparent substrate 290 may include a polymer material. According to another particular embodiment, the second transparent substrate 290 may consist of a polymer material. According to still other embodiments, the second transparent substrate 290 may be a polymer substrate layer. According to particular embodiments, the polymer substrate layer may include any desirable polymer material.

According to still other embodiments, the second transparent substrate 290 may include a polyethylene terephthalate (PET) material. According to another particular embodiment, the second transparent substrate 290 may consist of a PET material. According to still other embodiments, the second transparent substrate 290 may be a PET substrate layer. According to particular embodiments, the PET substrate layer may include any desirable polymer material.

According to yet another embodiment, the second transparent substrate 290 may include a glass material. According to yet another embodiment, the second transparent substrate 290 may consist of a glass material. According to still another embodiment, the second transparent substrate 290 may be a glass substrate layer. According to still other embodiments, the glass material may include any desirable glass material.

According to still other embodiments, when second transparent substrate 290 is a polymer substrate layer, it may have a particular thickness. For example, the second transparent substrate 290 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the second transparent substrate 290 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that second transparent substrate 290 may have a thickness within a range between any of minimum and maximum values noted above. It will be further appreciated that second transparent substrate 290 may have a thickness of any value between any of the minimum and maximum values noted above.

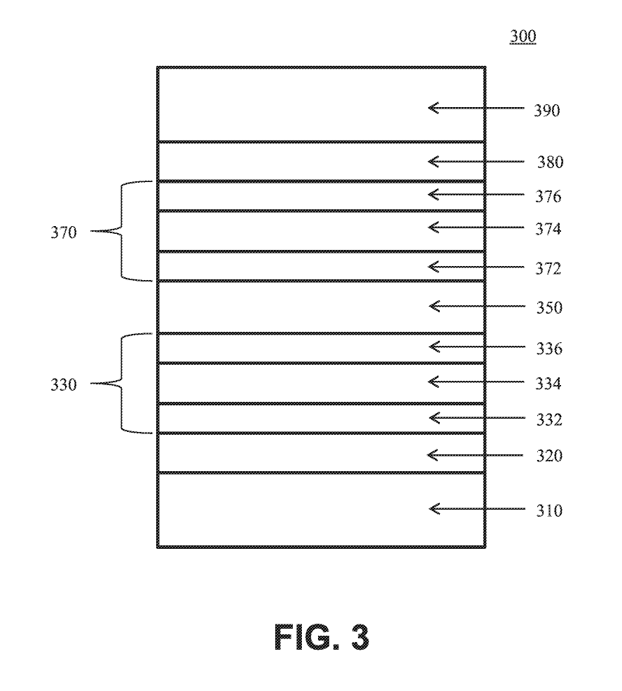

FIG. 3 includes an illustration of a cross-sectional view of a portion of another example composite film 300. As shown in FIG. 3, the composite film 300 may include a first transparent substrate 310, a first infra-red reflection stack 330, a second infra-red reflection stack 370, a first dielectric layer 350 located between that first infra-red reflection stack 330 and the second infra-red reflection stack 370, a second dielectric layer 320 located so that the first infra-red reflection stack 330 is located between the first dielectric layer 350 and the second dielectric layer 320, a third dielectric layer 380 located so that the second infra-red stack 370 is located between the first dielectric layer 350 and the third dielectric layer 380 and a second transparent substrate 390 located within the composite film 300 so that the first infra-red reflection stack 330, the second infra-red reflection stack 370, the first dielectric layer 350, the second dielectric layer 320 and the third dielectric layer 380 are all located between the first transparent substrate 310 and the second transparent substrate 390. The first infra-red reflection stack 330 may include a first blocker layer 332, the second blocker layer 336 and a first functional layer 334. The first blocker layer 332 may include NiCr. The second blocker layer 336 may include NiCr. The first functional layer 334 may include silver. The second infra-red reflection stack 370 may include a third blocker layer 372, a fourth blocker layer 376 and a second functional layer 374. The third blocker layer 372 may include NiCr. The second blocker layer 376 may include NiCr. The second functional layer 374 may include silver.

It will be appreciated that the composite film 300 and all layers described in reference to the composite film 300 may have any of the characteristics described herein with reference to corresponding layers in FIG. 1 or 2.

According to certain embodiments, the second dielectric layer 320 may include a dielectric material. According to still other embodiments, the second dielectric layer 320 may consist essentially of a dielectric material. The dielectric material of the second dielectric layer 320 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the second dielectric layer 320 may include any one of ITO, SnZnOₓ, SiOₓ, Si₃N₄, Nb₂Oₓ, TiOₓ, In₂Oₓ, ZnOₓ or AZO. According to still other embodiments, the second dielectric layer 320 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the second dielectric layer 320 may have a particular thickness. For example, the second dielectric layer 320 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the second dielectric layer 320 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the second dielectric layer 320 may have a thickness within a range between any of minimum and maximum values noted above. It will be further appreciated that the second dielectric layer 320 may have a thickness of any value between any of the minimum and maximum values noted above.

It will be appreciated that the second dielectric layer 320 may include multiple dielectric layers. It will be further appreciated that any dielectric layer making up the second dielectric layer 320 may have any of the characteristics described herein in reference to the second dielectric layer 320.

According to certain embodiments, the third dielectric layer 380 may include a dielectric material. According to still other embodiments, the third dielectric layer 380 may consist essentially of a dielectric material. The dielectric material of the third dielectric layer 380 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the third dielectric layer 380 may include any one of ITO, SnZnOₓ, SiOₓ, Si₃N₄, Nb₂Oₓ, TiOₓ, In₂Oₓ, ZnOₓ or AZO. According to still other embodiments, the third dielectric layer 380 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the third dielectric layer 380 may have a particular thickness. For example, the third dielectric layer 380 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the third dielectric layer 380 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the third dielectric layer 380 may have a thickness within a range between any of minimum and maximum values noted above. It will be further appreciated that the third dielectric layer 380 may have a thickness of any value between any of the minimum and maximum values noted above.

It will be appreciated that the third dielectric layer 380 may include multiple dielectric layers. It will be further appreciated that any dielectric layer making up the third dielectric layer 380 may have any of the characteristics described herein in reference to the third dielectric layer 380.

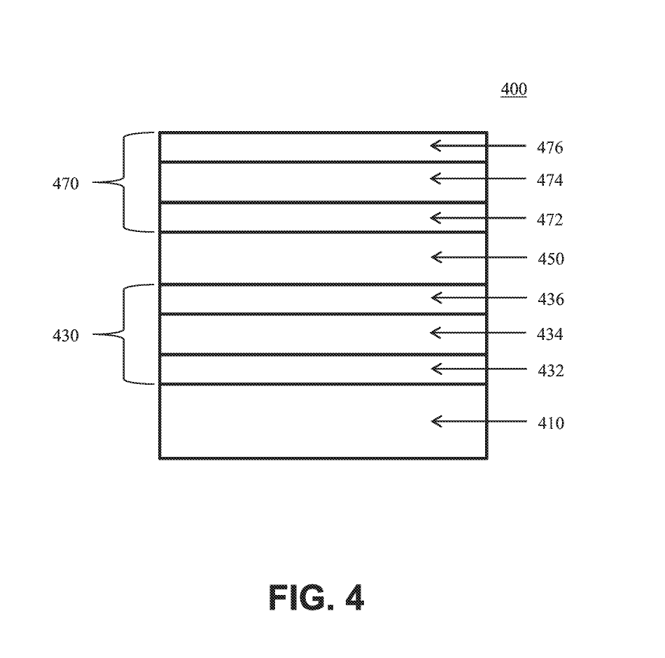

FIG. 4 includes an illustration of a cross-sectional view of a portion of an example composite window film 400. As shown in FIG. 4, the composite window film 400 may include a first transparent substrate 410, a first infra-red reflection stack 430, a second infra-red reflection stack 470 and a first dielectric layer 450 located between that first infra-red reflection stack 430 and the second infra-red reflection stack 470. The first infra-red reflection stack 430 may include a first blocker layer 432, the second blocker layer 436 and a first functional layer 434. The first blocker layer 432 may include NiCr and may have a thickness of at least about 0.2 nm and not greater than about 5 nm. The second blocker layer 436 may include NiCr and may have a thickness of at least about 0.2 nm and not greater than about 5 nm. The first functional layer 434 may include silver. The second infra-red reflection stack 470 may include a third blocker layer 472, a fourth blocker layer 476 and a second functional layer 474. The third blocker layer 472 may include NiCr and may have a thickness of at least about 0.2 nm and not greater than about 5 nm. The fourth blocker layer 476 may include NiCr and may have a thickness of at least about 0.2 nm and not greater than about 5 nm. The second functional layer 474 may include silver.

According to particular embodiments, the first transparent substrate 410 may include a polymer material. According to another particular embodiment, the first transparent substrate 410 may consist of a polymer material. According to still other embodiments, the first transparent substrate 410 may be a polymer substrate layer. According to particular embodiments, the polymer substrate layer may include any desirable polymer material.

According to still other embodiments, the first transparent substrate 410 may include a polyethylene terephthalate (PET) material. According to another particular embodiment, the first transparent substrate 410 may consist of a PET material. According to still other embodiments, the first transparent substrate 410 may be a PET substrate layer. According to particular embodiments, the PET substrate layer may include any desirable polymer material.

According to yet another embodiment, the first transparent substrate 410 may include a glass material. According to yet another embodiment, the first transparent substrate 410 may consist of a glass material. According to still another embodiment, the first transparent substrate 410 may be a glass substrate layer. According to still other embodiments, the glass material may include any desirable glass material.

According to still other embodiments, when the first transparent substrate 410 is a polymer substrate layer, it may have a particular thickness. For example, the first transparent substrate 410 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the first transparent substrate 410 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that the first transparent substrate 410 may have a thickness within a range between any of minimum and maximum values noted above. It will be further appreciated that the first transparent substrate 410 may have a thickness of any value between any of the minimum and maximum values noted above.

It will be further appreciated that when the first transparent substrate 410 is a glass substrate layer, it may have any desired thickness.

According to particular embodiments, the first functional layer 434 may include silver. According to yet another embodiment, the first functional layer 434 may consist essentially of silver. According to still another embodiment, the first functional layer 434 may be a silver layer.

According to still other embodiments, the first functional layer 434 may have a particular thickness. For example, the first functional layer 434 may have a thickness of at least about 5 nanometers, such as, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers, at least about 20 nanometers, at least about 25 nanometers, at least about 30 nanometers or even at least about 35 nanometers. According to still another embodiment, the first functional layer 434 may have a thickness of not greater than about 40 nanometers, such as, not greater than about 39 nanometers, not greater than about 38 nanometers, not greater than about 37 nanometers, not greater than about 36 nanometers, not greater than about 35 nanometers, not greater than about 34 nanometers, not greater than about 33 nanometers, not greater than about 32 nanometers or even not greater than about 31 nanometers. It will be appreciated that the first functional layer 434 may have a thickness within a range between any of minimum and maximum values noted above. It will be further appreciated that first functional layer 434 may have a thickness of any value between any of the minimum and maximum values noted above.

According to another embodiment, the first blocker layer 432 may include NiCr. According to still another embodiment, the first blocker layer 432 may consist essentially of NiCr. According to yet another embodiment, the first blocker layer 432 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the first blocker layer 432 may have a particular thickness. For example, the first blocker layer 432 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the first blocker layer 132 may have a thickness of at least about 0.1 nanometers, such as, at least about 0.2 nanometers, at least about 0.3 nanometers, at least about 0.4 nanometers. It will be appreciated that the first blocker layer 432 may have a thickness within a range between any of minimum and maximum values noted above. It will be further appreciated the first blocker layer 432 may have a thickness of any value between any of the minimum and maximum values noted above.

According to another embodiment, the second blocker layer 436 may include NiCr. According to still another embodiment, the second blocker layer 436 may consist essentially of NiCr. According to yet another embodiment, the second blocker layer 436 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the second blocker layer 436 may have a particular thickness. For example, the second blocker layer 436 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the second blocker layer 436 may have a thickness of at least about 0.1 nanometers, such as, at least about 0.2 nanometers, at least about 0.3 nanometers, at least about 0.4 nanometers. It will be appreciated that the second blocker layer 436 may have a thickness within a range between any of minimum and maximum values noted above. It will be further appreciated that the second blocker layer 436 may have a thickness of any value between any of the minimum and maximum values noted above.

According to particular embodiments, the second functional layer 474 may include silver. According to yet another embodiment, the second functional layer 474 may consist essentially of silver. According to still another embodiment, the second functional layer 474 may be a silver layer.

According to still other embodiments, the second functional layer 474 may have a particular thickness. For example, the second functional layer 474 may have a thickness of at least about 5 nanometers, such as, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers, at least about 20 nanometers, at least about 25 nanometers, at least about 30 nanometers or even at least about 35 nanometers. According to still another embodiment, the second functional layer 474 may have a thickness of not greater than about 40 nanometers, such as, not greater than about 39 nanometers, not greater than about 38 nanometers, not greater than about 37 nanometers, not greater than about 36 nanometers, not greater than about 35 nanometers, not greater than about 34 nanometers, not greater than about 33 nanometers, not greater than about 32 nanometers or even not greater than about 31 nanometers. It will be appreciated that the second functional layer 474 may have a thickness within a range between any of minimum and maximum values noted above. It will be further appreciated that second functional layer 474 may have a thickness of any value between any of the minimum and maximum values noted above.

According to another embodiment, the third blocker layer 472 may include NiCr. According to still another embodiment, the third blocker layer 472 may consist essentially of NiCr. According to yet another embodiment, the third blocker layer 472 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the third blocker layer 472 may have a particular thickness. For example, the third blocker layer 472 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the third blocker layer 472 may have a thickness of at least about 0.1 nanometers, such as, at least about 0.2 nanometers, at least about 0.3 nanometers, at least about 0.4 nanometers. It will be appreciated that the third blocker layer 472 may have a thickness within a range between any of minimum and maximum values noted above. It will be further appreciated the third blocker layer 472 may have a thickness of any value between any of the minimum and maximum values noted above.

According to another embodiment, the fourth blocker layer 476 may include NiCr. According to still another embodiment, the fourth blocker layer 476 may consist essentially of NiCr. According to yet another embodiment, the fourth blocker layer 476 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the fourth blocker layer 476 may have a particular thickness. For example, the fourth blocker layer 476 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers or even not greater than about 0.2 nanometers. According to yet another embodiment, the fourth blocker layer 476 may have a thickness of at least about 0.1 nanometers, such as, at least about 0.2 nanometers, at least about 0.3 nanometers, at least about 0.4 nanometers. It will be appreciated that the fourth blocker layer 476 may have a thickness within a range between any of minimum and maximum values noted above. It will be further appreciated that the fourth blocker layer 476 may have a thickness of any value between any of the minimum and maximum values.

According to certain embodiments, the first dielectric layer 450 may include a dielectric material. According to still other embodiments, the first dielectric layer 450 may consist essentially of a dielectric material. The dielectric material of the first dielectric layer 450 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the first dielectric layer 450 may include any one of ITO, SnZnOₓ, SiOₓ, Si₃N₄, Nb₂Oₓ, TiOₓ, In₂Oₓ, ZnOₓ or AZO. According to still other embodiments, the first dielectric layer 450 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the first dielectric layer 450 may have a particular thickness. For example, the first dielectric layer 450 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the first dielectric layer 450 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the first dielectric layer 450 may have a thickness within a range between any of minimum and maximum values noted above. It will be further appreciated that the first dielectric layer 450 may have a thickness of any value between any of the minimum and maximum values noted above.

It will be appreciated that the first dielectric layer 450 may include multiple dielectric layers. It will be further appreciated that any dielectric layer making up the first dielectric layer 450 may have any of the characteristics described herein in reference to the first dielectric layer 450.

According to yet another embodiment, the composite window film 400 may have a particular thickness ratio TH_{BL1}/TH_{FL1}, where TH_{BL1} is the thickness of the first blocker layer 432 and TH_{FL1} is the thickness of the first functional layer 434. For example, the composite window film 400 may have a ratio TH_{BL1}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 100 may have a ratio TH_{BL1}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 400 may have a ratio TH_{BL1}/TH_{FL1} of any value within a range between any of minimum and maximum values noted above. It will be further appreciated that the composite window film 400 may have a ratio TH_{BL1}/TH_{FL1} of any value between any of the minimum and maximum values noted above.

According to yet another embodiment, the composite window film 400 may have a particular thickness ratio TH_{BL2}/TH_{FL1}, where TH_{BL2} is the thickness of the second blocker layer 436 and TH_{FL1} is the thickness of the first functional layer 434. For example, the composite window film 400 may have a ratio TH_{BL2}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 100 may have a ratio TH_{BL2}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 400 may have a ratio TH_{BL2}/TH_{FL1} of any value within a range between any of minimum and maximum values noted above. It will be further appreciated that the composite window film 400 may have a ratio TH_{BL2}/TH_{FL1} of any value between any of the minimum and maximum values noted above.

According to yet another embodiment, the composite window film 400 may have a particular thickness ratio TH_{BL3}/TH_{FL2}, where TH_{BL3} is the thickness of the third blocker layer 472 and TH_{FL2} is the thickness of the second functional layer 474. For example, the composite window film 400 may have a ratio TH_{BL3}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 400 may have a ratio TH_{BL3}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 400 may have a ratio TH_{BL3}/TH_{FL2} of any value within a range between any of minimum and maximum values noted above. It will be further appreciated that the composite window film 400 may have a ratio TH_{BL3}/TH_{FL2} of any value between any of the minimum and maximum values noted above.

According to yet another embodiment, the composite window film 400 may have a particular thickness ratio TH_{BL4}/TH_{FL2}, where TH_{BL4} is the thickness of the fourth blocker layer 476 and TH_{FL2} is the thickness of the second functional layer 474. For example, the composite window film 400 may have a ratio TH_{BL4}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 400 may have a ratio TH_{BL4}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 400 may have a ratio TH_{BL4}/TH_{FL2} of any value within a range between any of minimum and maximum values noted above. It will be further appreciated that the composite window film 400 may have a ratio TH_{BL4}/TH_{FL2} of any value between any of the minimum and maximum values noted above.

According to yet other embodiments, the composite window film 400 may have a particular VLT. For example, the composite window film 400 may have a VLT of at least about 10%, at least about 15%, at least about 20%, at leas about 25%, at least about 30%, at least about 35%, at least about 40%, at least about 45%, at least about 50%, at least about 55%, at least about 60%, at least about 65%, at least about 70%, at least about 75%, at least about 80%, at least about 85% at least about 85% or even at least about 90%. According to still another embodiment, the composite window film 400 may have a VLT of not greater than about 99%. It will be appreciated that the composite window film 400 may have a VLT within a range between any of minimum and maximum values noted above. It will be further appreciated that the composite window film 400 have a VLT of any value between any of the minimum and maximum values noted above.

According to still another embodiment, the composite window film 400 may have a particular TSER. For example, the composite window film 400 may have a TSER of at least about 40%, such as, at least about 45%, at least about 50%, at least about 55%, at least about 60%, at least about 65% or even at least about 70%. According to yet other embodiments, the composite window film 400 may have a TSER of not greater than about 85%, such as, not greater than about 80%, not greater than about 75% or even not greater than about 70%. It will be appreciated that the composite window film 400 may have a TSER within a range between any of minimum and maximum values noted above. It will be further appreciated that the composite window film 400 may have a TSER of any value between any of the minimum and maximum values noted above.

According to yet other embodiments, the composite window film 400 may have a particular Solar Control Ratio VLT/(100%-TSER). For example, the composite window film 400 may have a Solar Control Ratio of at least about 0.5, such as, at least about 0.6, at least about 0.7, at least about 0.8, at least about 0.9, at least about 1.0, at least about 1.1, at least about 1.2, at least about 1.3, at least about 1.4 or even at least about 1.5. According to still other embodiments, the composite window film 400 may have a Solar Control Ratio of not greater than about 2.0, such as, not greater than about 1.9, not greater than about 1.8, not greater than about 1.7 or even not greater than about 1.6. It will be appreciated that the composite window film 400 may have a Solar Control Ratio within a range between any of minimum and maximum values noted above. It will be further appreciated that the composite window film 400 may have a Solar Control Ratio of any value between any of the minimum and maximum values noted above.

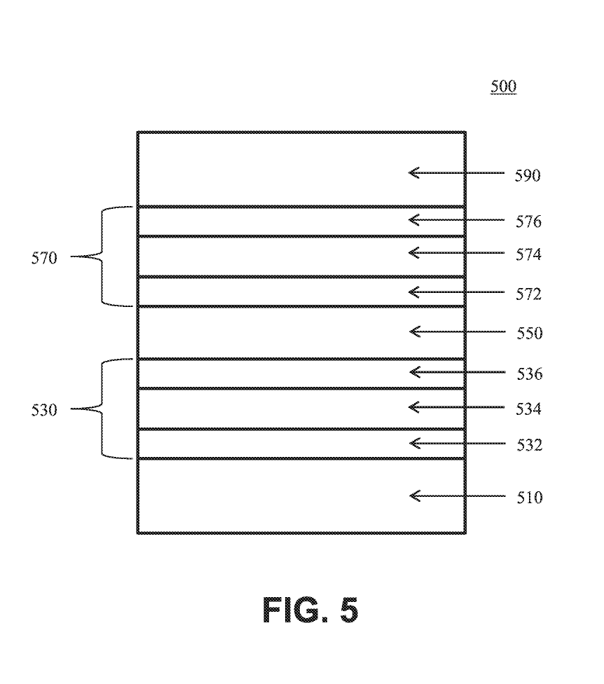

FIG. 5 includes an illustration of a cross-sectional view of a portion of another example composite window film 500. As shown in FIG. 5, the composite window film 500 may include a first transparent substrate 510, a first infra-red reflection stack 530, a second infra-red reflection stack 570, a first dielectric layer 550 located between that first infra-red reflection stack 530 and the second infra-red reflection stack 570 and a second transparent substrate 590 located within the film so that the first infra-red reflection stack 530, the second infra-red reflection stack 570 and the first dielectric layer 550 are all located between the first transparent substrate 510 and the second transparent substrate 590. The first infra-red reflection stack 530 may include a first blocker layer 532, the second blocker layer 536 and a first functional layer 534. The first blocker layer 532 may include NiCr and may have a thickness of at least about 0.2 nm and not greater than about 5 nm. The second blocker layer 536 may include NiCr and may have a thickness of at least about 0.2 nm and not greater than about 5 nm. The first functional layer 534 may include silver. The second infra-red reflection stack 570 may include a third blocker layer 572, a fourth blocker layer 576 and a second functional layer 574. The third blocker layer 572 may include NiCr and may have a thickness of at least about 0.2 nm and not greater than about 5 nm. The second blocker layer 576 may include NiCr and may have a thickness of at least about 0.2 nm and not greater than about 5 nm. The second functional layer 574 may include silver.

It will be appreciated that the composite window film 500 and all layer described in reference to the composite window film 500 may have any of the characteristics described herein with reference to corresponding layers in FIG. 4.

According to particular embodiments, the second transparent substrate 590 may include a polymer material. According to another particular embodiment, the second transparent substrate 590 may consist of a polymer material. According to still other embodiments, the second transparent substrate 590 may be a polymer substrate layer. According to particular embodiments, the polymer substrate layer may include any desirable polymer material.

According to still other embodiments, the second transparent substrate 290 may include a polyethylene terephthalate (PET) material. According to another particular embodiment, the second transparent substrate 590 may consist of a PET material. According to still other embodiments, the second transparent substrate 590 may be a PET substrate layer. According to particular embodiments, the PET substrate layer may include any desirable polymer material.

According to yet another embodiment, the second transparent substrate 590 may include a glass material. According to yet another embodiment, the second transparent substrate 590 may consist of a glass material. According to still another embodiment, the second transparent substrate 590 may be a glass substrate layer. According to still other embodiments, the glass material may include any desirable glass material.

According to still other embodiments, when second transparent substrate 590 is a polymer substrate layer, it may have a particular thickness. For example, the second transparent substrate 590 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the second transparent substrate 590 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that second transparent substrate 590 may have a thickness within a range between any of minimum and maximum values noted above. It will be further appreciated that second transparent substrate 590 may have a thickness of any value between any of the minimum and maximum values noted above.

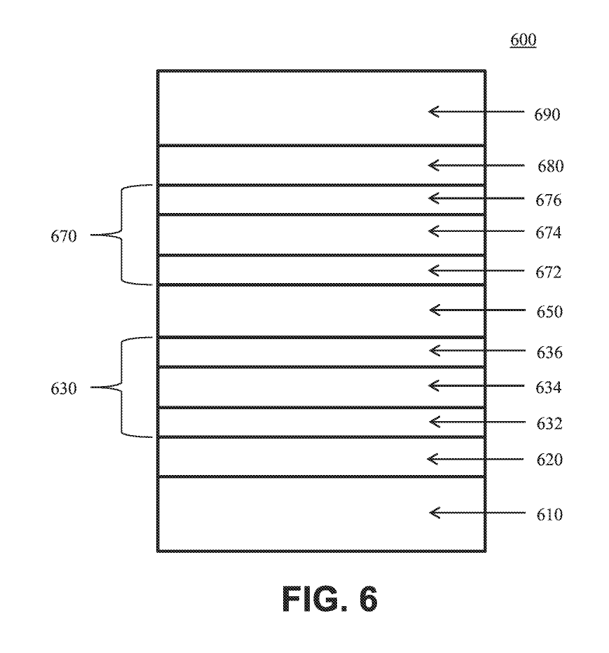

FIG. 6 includes an illustration of a cross-sectional view of a portion of another example composite window film 600. As shown in FIG. 6, the composite window film 600 may include a first transparent substrate 610, a first infra-red reflection stack 630, a second infra-red reflection stack 670, a first dielectric layer 650 located between that first infra-red reflection stack 630 and the second infra-red reflection stack 670, a second dielectric layer 60 located so that the first infra-red reflection stack 630 is located between the first dielectric layer 650 and the second dielectric layer 620, a third dielectric layer 680 located so that the second infra-red stack 670 is located between the first dielectric layer 650 and the third dielectric layer 680 and a second transparent substrate 690 located within the composite window film 600 so that the first infra-red reflection stack 630, the second infra-red reflection stack 670, the first dielectric layer 650, the second dielectric layer 620 and the third dielectric layer 680 are all located between the first transparent substrate 610 and the second transparent substrate 690. The first infra-red reflection stack 630 may include a first blocker layer 632, the second blocker layer 636 and a first functional layer 634. The first blocker layer 632 may include NiCr and may have a thickness of at least about 0.2 nm and not greater than about 5 nm. The second blocker layer 636 may include NiCr and may have a thickness of at least about 0.2 nm and not greater than about 5 nm. The first functional layer 634 may include silver. The second infra-red reflection stack 670 may include a third blocker layer 672, a fourth blocker layer 676 and a second functional layer 674. The third blocker layer 672 may include NiCr and may have a thickness of at least about 0.2 nm and not greater than about 5 nm. The second blocker layer 676 may include NiCr and may have a thickness of at least about 0.2 nm and not greater than about 5 nm. The second functional layer 674 may include silver.

It will be appreciated that the composite window film 600 and all layer described in reference to the composite window film 600 may have any of the characteristics described herein with reference to corresponding layers in FIG. 4 or 5.

According to certain embodiments, the second dielectric layer 620 may include a dielectric material. According to still other embodiments, the second dielectric layer 620 may consist essentially of a dielectric material. The dielectric material of the second dielectric layer 620 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the second dielectric layer 620 may include any one of ITO, SnZnOₓ, SiOₓ, Si₃N₄, Nb₂Oₓ, TiOₓ, In₂Oₓ, ZnOₓ or AZO. According to still other embodiments, the second dielectric layer 620 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the second dielectric layer 620 may have a particular thickness. For example, the second dielectric layer 620 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the second dielectric layer 620 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the second dielectric layer 620 may have a thickness within a range between any of minimum and maximum values noted above. It will be further appreciated that the second dielectric layer 620 may have a thickness of any value between any of the minimum and maximum values noted above.

It will be appreciated that the second dielectric layer 620 may include multiple dielectric layers. It will be further appreciated that any dielectric layer making up the second dielectric layer 620 may have any of the characteristics described herein in reference to the second dielectric layer 620.

According to certain embodiments, the third dielectric layer 680 may include a dielectric material. According to still other embodiments, the third dielectric layer 680 may consist essentially of a dielectric material. The dielectric material of the third dielectric layer 380 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the third dielectric layer 680 may include any one of ITO, SnZnOₓ, SiOₓ, Si₃N₄, Nb₂Oₓ, TiOₓ, In₂Oₓ, ZnOₓ or AZO. According to still other embodiments, the third dielectric layer 680 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the third dielectric layer 680 may have a particular thickness. For example, the third dielectric layer 680 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the third dielectric layer 680 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the third dielectric layer 680 may have a thickness within a range between any of minimum and maximum values noted above. It will be further appreciated that the third dielectric layer 680 may have a thickness of any value between any of the minimum and maximum values noted above.

It will be appreciated that the third dielectric layer 680 may include multiple dielectric layers. It will be further appreciated that any dielectric layer making up the third dielectric layer 680 may have any of the characteristics described herein in reference to the third dielectric layer 680.

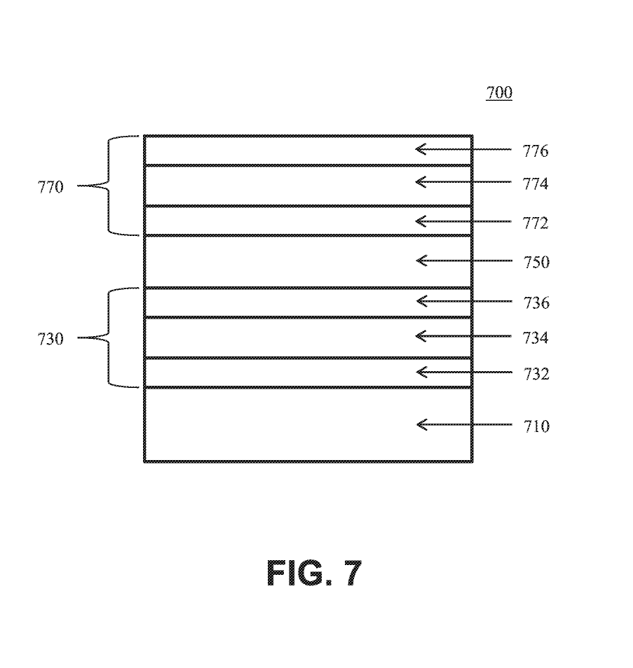

FIG. 7 includes an illustration of a cross-sectional view of a portion of an example composite window film 700 configured for application on a sunroof. As shown in FIG. 7, the composite window film 700 may include a first transparent substrate 710, a first infra-red reflection stack 730, a second infra-red reflection stack 770 and a first dielectric layer 750 located between that first infra-red reflection stack 730 and the second infra-red reflection stack 770. The first infra-red reflection stack 730 may include a first blocker layer 732, the second blocker layer 736 and a first functional layer 734. The first blocker layer 732 may include NiCr and may have a thickness of at least about 1 nm and not greater than about 5 nm. The second blocker layer 736 may include NiCr and may have a thickness of at least about 1 nm and not greater than about 5 nm. The first functional layer 734 may include silver. The second infra-red reflection stack 770 may include a third blocker layer 772, a fourth blocker layer 776 and a second functional layer 774. The third blocker layer 772 may include NiCr and may have a thickness of at least about 1 nm and not greater than about 5 nm. The fourth blocker layer 776 may include NiCr and may have a thickness of at least about 1 nm and not greater than about 5 nm. The second functional layer 774 may include silver.

According to particular embodiments, the first transparent substrate 710 may include a polymer material. According to another particular embodiment, the first transparent substrate 710 may consist of a polymer material. According to still other embodiments, the first transparent substrate 710 may be a polymer substrate layer. According to particular embodiments, the polymer substrate layer may include any desirable polymer material.

According to still other embodiments, the first transparent substrate 710 may include a polyethylene terephthalate (PET) material. According to another particular embodiment, the first transparent substrate 710 may consist of a PET material. According to still other embodiments, the first transparent substrate 710 may be a PET substrate layer. According to particular embodiments, the PET substrate layer may include any desirable polymer material.

According to yet another embodiment, the first transparent substrate 710 may include a glass material. According to yet another embodiment, the first transparent substrate 710 may consist of a glass material. According to still another embodiment, the first transparent substrate 710 may be a glass substrate layer. According to still other embodiments, the glass material may include any desirable glass material.

According to still other embodiments, when the first transparent substrate 710 is a polymer substrate layer, it may have a particular thickness. For example, the first transparent substrate 710 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the first transparent substrate 710 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that the first transparent substrate 710 may have a thickness within a range between any of minimum and maximum values noted above. It will be further appreciated that the first transparent substrate 710 may have a thickness of any value between any of the minimum and maximum values noted above.

It will be further appreciated that when the first transparent substrate 710 is a glass substrate layer, it may have any desired thickness.

According to particular embodiments, the first functional layer 734 may include silver. According to yet another embodiment, the first functional layer 734 may consist essentially of silver. According to still another embodiment, the first functional layer 734 may be a silver layer.

According to still other embodiments, the first functional layer 734 may have a particular thickness. For example, the first functional layer 734 may have a thickness of at least about 8 nanometers, such as, at least about 9 nanometers, at least about 10 nanometers or even at least about 12 nanometers. According to still another embodiment, the first functional layer 734 may have a thickness of not greater than about 13 nanometers, such as, not greater than about 12 nanometers or even not greater than about 11 nanometers. It will be appreciated that the first functional layer 734 may have a thickness within a range between any of minimum and maximum values noted above. It will be further appreciated that first functional layer 734 may have a thickness of any value between any of the minimum and maximum values noted above.

According to another embodiment, the first blocker layer 732 may include NiCr. According to still another embodiment, the first blocker layer 732 may consist essentially of NiCr. According to yet another embodiment, the first blocker layer 732 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the first blocker layer 732 may have a particular thickness. For example, the first blocker layer 732 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers or even not greater than about 2.0 nanometers. According to yet another embodiment, the first blocker layer 132 may have a thickness of at least about 1 nanometers, such as, at least about 1.2 nanometers, at least about 1.3 nanometers or even at least about 1.4 nanometers. It will be appreciated that the first blocker layer 732 may have a thickness within a range between any of minimum and maximum values noted above. It will be further appreciated the first blocker layer 732 may have a thickness of any value between any of the minimum and maximum values noted above.

According to another embodiment, the second blocker layer 736 may include NiCr. According to still another embodiment, the second blocker layer 736 may consist essentially of NiCr. According to yet another embodiment, the second blocker layer 736 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the second blocker layer 736 may have a particular thickness. For example, the second blocker layer 736 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers or even not greater than about 2.0 nanometers. According to yet another embodiment, the second blocker layer 736 may have a thickness of at least about 1 nanometers, such as, at least about 1.2 nanometers, at least about 1.3 nanometers or even at least about 1.4 nanometers. It will be appreciated that the second blocker layer 736 may have a thickness within a range between any of minimum and maximum values noted above. It will be further appreciated that the second blocker layer 736 may have a thickness of any value between any of the minimum and maximum values noted above.

According to particular embodiments, the second functional layer 774 may include silver. According to yet another embodiment, the second functional layer 774 may consist essentially of silver. According to still another embodiment, the second functional layer 774 may be a silver layer.

According to still other embodiments, the second functional layer 774 may have a particular thickness. For example, the second functional layer 774 may have a thickness of at least about 8 nanometers, such as, at least about 9 nanometers, at least about 10 nanometers, at least about 11 nanometers or even at least about 12 nanometers. According to still another embodiment, the second functional layer 774 may have a thickness of not greater than about 13 nanometers, such as, not greater than about 12 nanometers or even not greater than about 11 nanometers. It will be appreciated that the second functional layer 774 may have a thickness within a range between any of minimum and maximum values noted above. It will be further appreciated that second functional layer 774 may have a thickness of any value between any of the minimum and maximum values noted above.

According to another embodiment, the third blocker layer 772 may include NiCr. According to still another embodiment, the third blocker layer 772 may consist essentially of NiCr. According to yet another embodiment, the third blocker layer 772 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the third blocker layer 772 may have a particular thickness. For example, the third blocker layer 772 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers or even not greater than about 2.0 nanometers. According to yet another embodiment, the third blocker layer 772 may have a thickness of at least about 1 nanometers, such as, at least about 1.2 nanometers, at least about 1.3 nanometers, at least about 1.4 nanometers. It will be appreciated that the third blocker layer 772 may have a thickness within a range between any of minimum and maximum values noted above. It will be further appreciated the third blocker layer 772 may have a thickness of any value between any of the minimum and maximum values noted above.

According to another embodiment, the fourth blocker layer 776 may include NiCr. According to still another embodiment, the fourth blocker layer 776 may consist essentially of NiCr. According to yet another embodiment, the fourth blocker layer 776 may be referred to as a NiCr layer.

According to still other embodiments, the NiCr may have a particular alloy composition described as having a particular weight percent Ni for a total weight of the NiCr alloy and a particular weight percent Cr for a total weigh of the NiCr. According to a particular embodiment, the NiCr alloy composition may be 80 wt. % Ni for a total weight of the NiCr and 20 wt. % Cr for a total weight of the NiCr.

According to still another embodiment, the fourth blocker layer 776 may have a particular thickness. For example, the fourth blocker layer 776 may have a thickness of not greater than about 5 nanometers, such as, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers or even not greater than about 2.0 nanometers. According to yet another embodiment, the fourth blocker layer 776 may have a thickness of at least about 1 nanometers, such as, at least about 1.2 nanometers, at least about 1.3 nanometers, at least about 1.4 nanometers. It will be appreciated that the fourth blocker layer 776 may have a thickness within a range between any of minimum and maximum values noted above. It will be further appreciated that the fourth blocker layer 776 may have a thickness of any value between any of the minimum and maximum values.

According to certain embodiments, the first dielectric layer 750 may include a dielectric material. According to still other embodiments, the first dielectric layer 750 may consist essentially of a dielectric material. The dielectric material of the first dielectric layer 750 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the first dielectric layer 750 may include any one of ITO, SnZnOₓ, SiOₓ, Si₃N₄, Nb₂Oₓ, TiOₓ, In₂Oₓ, ZnOₓ or AZO. According to still other embodiments, the first dielectric layer 750 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the first dielectric layer 750 may have a particular thickness. For example, the first dielectric layer 750 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the first dielectric layer 750 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the first dielectric layer 750 may have a thickness within a range between any of minimum and maximum values noted above. It will be further appreciated that the first dielectric layer 750 may have a thickness of any value between any of the minimum and maximum values noted above.

It will be appreciated that the first dielectric layer 750 may include multiple dielectric layers. It will be further appreciated that any dielectric layer making up the first dielectric layer 750 may have any of the characteristics described herein in reference to the first dielectric layer 750.

According to yet another embodiment, the composite window film 700 may have a particular thickness ratio TH_{BL1}/TH_{FL1}, where TH_{BL1} is the thickness of the first blocker layer 732 and TH_{FL1} is the thickness of the first functional layer 734. For example, the composite window film 700 may have a ratio TH_{BL1}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 700 may have a ratio TH_{BL1}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 700 may have a ratio TH_{BL1}/TH_{FL1} of any value within a range between any of minimum and maximum values noted above. It will be further appreciated that the composite window film 700 may have a ratio TH_{BL1}/TH_{FL1} of any value between any of the minimum and maximum values noted above.

According to yet another embodiment, the composite window film 700 may have a particular thickness ratio TH_{BL2}/TH_{FL1}, where TH_{BL2} is the thickness of the second blocker layer 736 and TH_{FL1} is the thickness of the first functional layer 734. For example, the composite window film 700 may have a ratio TH_{BL2}/TH_{FL1} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 700 may have a ratio TH_{BL2}/TH_{FL1} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 700 may have a ratio TH_{BL2}/TH_{FL1} of any value within a range between any of minimum and maximum values noted above. It will be further appreciated that the composite window film 700 may have a ratio TH_{BL2}/TH_{FL1} of any value between any of the minimum and maximum values noted above.

According to yet another embodiment, the composite window film 700 may have a particular thickness ratio TH_{BL3}/TH_{FL2}, where TH_{BL3} is the thickness of the third blocker layer 772 and TH_{FL2} is the thickness of the second functional layer 774. For example, the composite window film 700 may have a ratio TH_{BL3}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 700 may have a ratio TH_{BL3}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 700 may have a ratio TH_{BL3}/TH_{FL2} of any value within a range between any of minimum and maximum values noted above. It will be further appreciated that the composite window film 700 may have a ratio TH_{BL3}/TH_{FL2} of any value between any of the minimum and maximum values noted above.

According to yet another embodiment, the composite window film 700 may have a particular thickness ratio TH_{BL4}/TH_{FL2}, where TH_{BL4} is the thickness of the fourth blocker layer 776 and TH_{FL2} is the thickness of the second functional layer 774. For example, the composite window film 700 may have a ratio TH_{BL4}/TH_{FL2} of not greater than about 0.5, such as, not greater than about 0.45, not greater than about 0.4, not greater than about 0.35, not greater than about 0.3, not greater than about 0.25, not greater than about 0.2, not greater than about 0.15, not greater than about 0.1 or even not greater than about 0.05. According to still another embodiment, the composite window film 700 may have a ratio TH_{BL4}/TH_{FL2} of at least about 0.01, such as, at least about 0.02, at least about 0.03, at least about 0.04, at least about 0.05, at least about 0.06, at least about 0.07, at least about 0.08, at least about 0.09 or even at least about 0.1. It will be appreciated that the composite window film 700 may have a ratio TH_{BL4}/TH_{FL2} of any value within a range between any of minimum and maximum values noted above. It will be further appreciated that the composite window film 700 may have a ratio TH_{BL4}/TH_{FL2} of any value between any of the minimum and maximum values noted above.

According to yet other embodiments, the composite window film 700 may have a particular VLT. For example, the composite window film 700 may have a VLT of at least about 10%, at least about 15%, at least about 20%, at leas about 25%, at least about 30%, at least about 35%, at least about 40%, at least about 45%, at least about 50%, at least about 55%, at least about 60%, at least about 65%, at least about 70%, at least about 75%, at least about 80%, at least about 85% at least about 85% or even at least about 90%. According to still another embodiment, the composite window film 400 may have a VLT of not greater than about 99%. It will be appreciated that the composite window film 700 may have a VLT within a range between any of minimum and maximum values noted above. It will be further appreciated that the composite window film 700 have a VLT of any value between any of the minimum and maximum values noted above.

According to still another embodiment, the composite window film 700 may have a particular TSER. For example, the composite window film 700 may have a TSER of at least about 40%, such as, at least about 45%, at least about 50%, at least about 55%, at least about 60%, at least about 65% or even at least about 70%. According to yet other embodiments, the composite window film 700 may have a TSER of not greater than about 85%, such as, not greater than about 80%, not greater than about 75% or even not greater than about 70%. It will be appreciated that the composite window film 700 may have a TSER within a range between any of minimum and maximum values noted above. It will be further appreciated that the composite window film 700 may have a TSER of any value between any of the minimum and maximum values noted above.

According to yet other embodiments, the composite window film 700 may have a particular Solar Control Ratio VLT/(100%-TSER). For example, the composite window film 700 may have a Solar Control Ratio of at least about 0.5, such as, at least about 0.6, at least about 0.7, at least about 0.8, at least about 0.9, at least about 1.0, at least about 1.1, at least about 1.2, at least about 1.3, at least about 1.4 or even at least about 1.5. According to still other embodiments, the composite window film 700 may have a Solar Control Ratio of not greater than about 2.0, such as, not greater than about 1.9, not greater than about 1.8, not greater than about 1.7 or even not greater than about 1.6. It will be appreciated that the composite window film 700 may have a Solar Control Ratio within a range between any of minimum and maximum values noted above. It will be further appreciated that the composite window film 700 may have a Solar Control Ratio of any value between any of the minimum and maximum values noted above.

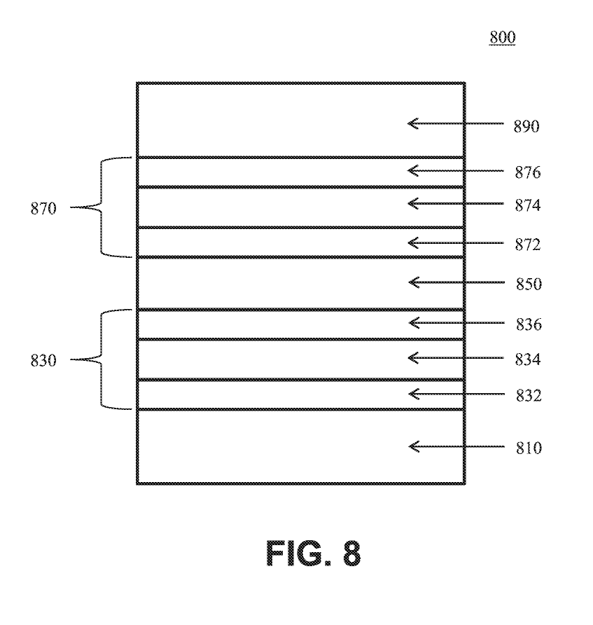

FIG. 8 includes an illustration of a cross-sectional view of a portion of another example composite window film 800 configured for application on a sunroof. As shown in FIG. 8, the composite window film 800 may include a first transparent substrate 810, a first infra-red reflection stack 830, a second infra-red reflection stack 870, a first dielectric layer 850 located between that first infra-red reflection stack 830 and the second infra-red reflection stack 870 and a second transparent substrate 890 located within the film so that the first infra-red reflection stack 830, the second infra-red reflection stack 870 and the first dielectric layer 850 are all located between the first transparent substrate 810 and the second transparent substrate 890. The first infra-red reflection stack 830 may include a first blocker layer 832, the second blocker layer 836 and a first functional layer 834. The first blocker layer 832 may include NiCr and may have a thickness of at least about 1 nm and not greater than about 5 nm. The second blocker layer 836 may include NiCr and may have a thickness of at least about 1 nm and not greater than about 5 nm. The first functional layer 534 may include silver. The second infra-red reflection stack 870 may include a third blocker layer 872, a fourth blocker layer 876 and a second functional layer 874. The third blocker layer 872 may include NiCr and may have a thickness of at least about 1 nm and not greater than about 5 nm. The second blocker layer 876 may include NiCr and may have a thickness of at least about 1 nm and not greater than about 5 nm. The second functional layer 874 may include silver.

It will be appreciated that the composite window film 800 and all layer described in reference to the composite window film 800 may have any of the characteristics described herein with reference to corresponding layers in FIG. 7.

According to particular embodiments, the second transparent substrate 890 may include a polymer material. According to another particular embodiment, the second transparent substrate 890 may consist of a polymer material. According to still other embodiments, the second transparent substrate 890 may be a polymer substrate layer. According to particular embodiments, the polymer substrate layer may include any desirable polymer material.

According to yet another embodiment, the second transparent substrate 790 may include a glass material. According to yet another embodiment, the second transparent substrate 890 may consist of a glass material. According to still another embodiment, the second transparent substrate 890 may be a glass substrate layer. According to still other embodiments, the glass material may include any desirable glass material.

According to still other embodiments, when second transparent substrate 890 is a polymer substrate layer, it may have a particular thickness. For example, the second transparent substrate 890 may have a thickness of at least about 10 microns, such as, at least about 15 microns, at least about 20 microns, at least about 25 microns, at least about 30 microns, at least about 35 microns, at least about 40 microns, at least about 45 microns, at least about 50 microns, at least about 75 microns, at least about 100 micron or even at least about 125 microns. According to still another embodiment, the second transparent substrate 890 may have a thickness of not greater than about 250 microns, such as, not greater than about 245 microns, not greater than about 240 microns, not greater than about 235 microns, not greater than about 230 microns, not greater than about 225 microns, not greater than about 220 microns, not greater than about 215 microns, not greater than about 210 microns, not greater than about 205 microns, not greater than about 200 microns, not greater than about 175 microns or even not greater than about 150 microns. It will be appreciated that second transparent substrate 890 may have a thickness within a range between any of minimum and maximum values noted above. It will be further appreciated that second transparent substrate 890 may have a thickness of any value between any of the minimum and maximum values noted above.

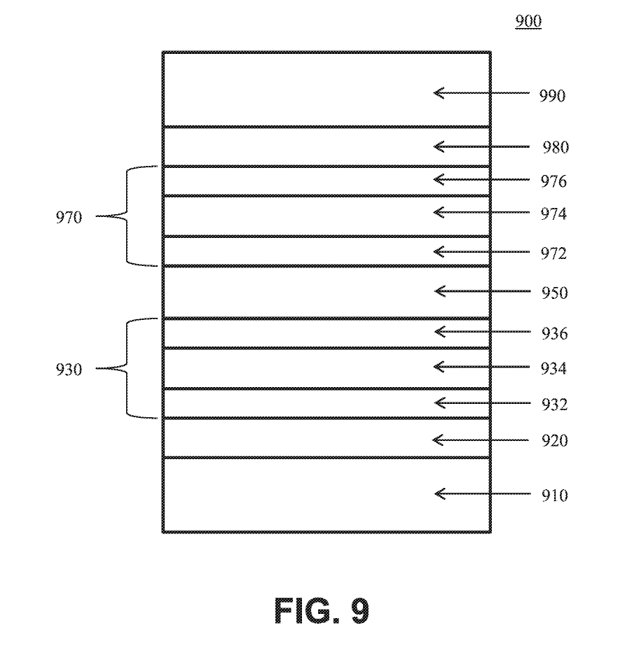

FIG. 9 includes an illustration of a cross-sectional view of a portion of another example composite window film 900. As shown in FIG. 9, the composite window film 900 may include a first transparent substrate 910, a first infra-red reflection stack 930, a second infra-red reflection stack 970, a first dielectric layer 950 located between that first infra-red reflection stack 930 and the second infra-red reflection stack 970, a second dielectric layer 920 located so that the first infra-red reflection stack 930 is located between the first dielectric layer 950 and the second dielectric layer 920, a third dielectric layer 980 located so that the second infra-red stack 970 is located between the first dielectric layer 950 and the third dielectric layer 980 and a second transparent substrate 990 located within the composite window film 900 so that the first infra-red reflection stack 930, the second infra-red reflection stack 970, the first dielectric layer 950, the second dielectric layer 920 and the third dielectric layer 980 are all located between the first transparent substrate 910 and the second transparent substrate 990. The first infra-red reflection stack 930 may include a first blocker layer 932, the second blocker layer 936 and a first functional layer 934. The first blocker layer 932 may include NiCr and may have a thickness of at least about 1 nm and not greater than about 5 nm. The second blocker layer 936 may include NiCr and may have a thickness of at least about 1 nm and not greater than about 5 nm. The first functional layer 934 may include silver. The second infra-red reflection stack 970 may include a third blocker layer 972, a fourth blocker layer 976 and a second functional layer 974. The third blocker layer 972 may include NiCr and may have a thickness of at least about 1 nm and not greater than about 5 nm. The second blocker layer 976 may include NiCr and may have a thickness of at least about 1 nm and not greater than about 5 nm. The second functional layer 674 may include silver.

It will be appreciated that the composite window film 900 and all layer described in reference to the composite window film 900 may have any of the characteristics described herein with reference to corresponding layers in FIG. 7 or 8.

According to certain embodiments, the second dielectric layer 920 may include a dielectric material. According to still other embodiments, the second dielectric layer 920 may consist essentially of a dielectric material. The dielectric material of the second dielectric layer 920 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the second dielectric layer 920 may include any one of ITO, SnZnOₓ, SiOₓ, Si₃N₄, Nb₂Oₓ, TiOₓ, In₂Oₓ, ZnOₓ or AZO. According to still other embodiments, the second dielectric layer 920 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the second dielectric layer 920 may have a particular thickness. For example, the second dielectric layer 920 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the second dielectric layer 920 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the second dielectric layer 920 may have a thickness within a range between any of minimum and maximum values noted above. It will be further appreciated that the second dielectric layer 920 may have a thickness of any value between any of the minimum and maximum values noted above.

It will be appreciated that the second dielectric layer 920 may include multiple dielectric layers. It will be further appreciated that any dielectric layer making up the second dielectric layer 920 may have any of the characteristics described herein in reference to the second dielectric layer 920.

According to certain embodiments, the third dielectric layer 980 may include a dielectric material. According to still other embodiments, the third dielectric layer 980 may consist essentially of a dielectric material. The dielectric material of the third dielectric layer 980 may be any known transparent dielectric material, such as, any one of ITO, SnZnOₓ, SiOₓ, Si₃N₄, Nb₂Oₓ, TiOₓ, In₂Oₓ, ZnOₓ or AZO. According to certain embodiments, the third dielectric layer 680 may include any one of ITO, SnZnOₓ, SiOₓ, Si₃N₄, Nb₂Oₓ, TiOₓ, In₂Oₓ, ZnOₓ or AZO. According to still other embodiments, the third dielectric layer 980 may consist essentially of any one of ITO, SnZnOₓ, SiOₓ, Si₃N₄, Nb₂Oₓ, TiOₓ, In₂Oₓ, ZnOₓ or AZO.

According to yet another embodiment, the third dielectric layer 980 may have a particular thickness. For example, the third dielectric layer 980 may have a thickness of not greater than about 200 nanometers, such as, not greater than about 190 nanometers, not greater than about 180 nanometers, not greater than about 170 nanometers, not greater than about 160 nanometers, not greater than about 150 nanometers, not greater than about 140 nanometers, not greater than about 130 nanometers, not greater than about 120 nanometers, not greater than about 110 nanometers, not greater than about 100 nanometers, not greater than about 95 nanometers, not greater than about 90 nanometers, not greater than about 85 nanometers, not greater than about 80 nanometers, not greater than about 75 nanometers, not greater than about 70 nanometers, not greater than about 65 nanometers, not greater than about 60 nanometers, not greater than about 55 nanometers, not greater than about 50 nanometers, not greater than about 45 nanometers, not greater than about 40 nanometers, not greater than about 35 nanometers, not greater than about 30 nanometers, not greater than about 30 nanometers, not greater than about 25 nanometers, not greater than about 20 nanometers or even not greater than about 15. According to still another embodiment, the third dielectric layer 980 may have a thickness of at least about 3 nanometers, such as, at least about 5 nanometers, at least about 8 nanometers, at least about 10 nanometers, at least about 20 nanometers, at least about 25 nanometers or even at least about 30 nanometers. It will be appreciated that the third dielectric layer 980 may have a thickness within a range between any of minimum and maximum values noted above. It will be further appreciated that the third dielectric layer 980 may have a thickness of any value between any of the minimum and maximum values noted above.

It will be appreciated that the third dielectric layer 980 may include multiple dielectric layers. It will be further appreciated that any dielectric layer making up the third dielectric layer 980 may have any of the characteristics described herein in reference to the third dielectric layer 980.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A composite film comprising: a first transparent substrate; a dielectric layer; and at least two infra-red reflection stacks, wherein the dielectric layer is located between the at least two infra-red reflection stacks; and wherein each infra-red reflection stack comprises: two blocker layers comprising NiCr; and a functional layer comprising silver between the two blocker layers.

### Embodiment 2

A composite film comprising: a first transparent substrate; a first dielectric layer adjacent to the first transparent substrate layer; a first blocker layer comprising NiCr adjacent to the first dielectric layer; a first functional layer comprising silver adjacent to the first blocker layer; a second blocker layer comprising NiCr adjacent to the first functional layer; a second dielectric layer adjacent to the second blocker layer; a third blocker layer comprising NiCr adjacent to the second dielectric layer; a second functional layer comprising silver adjacent to the third blocker layer; a fourth blocker layer comprising NiCr adjacent to the second functional layer; a third dielectric layer adjacent to the fourth blocker layer; and a second transparent substrate adjacent (Overlying) to the third dielectric layer.

### Embodiment 3

A method of forming composite film, wherein the method comprises: providing a first transparent substrate; forming a first dielectric layer adjacent to the first transparent substrate layer; forming a first blocker layer comprising NiCr adjacent to the first dielectric layer; forming a first functional layer comprising silver adjacent to the first blocker layer; forming a second blocker layer comprising NiCr adjacent to the first functional layer; forming a second dielectric layer adjacent to the second blocker layer; forming a third blocker layer comprising NiCr adjacent to the second dielectric layer; forming a second functional layer comprising silver adjacent to the third blocker layer; forming a fourth blocker layer comprising NiCr adjacent to the second functional layer; forming a third dielectric layer adjacent to the fourth blocker layer; and providing a second transparent substrate adjacent to the third dielectric layer.

### Embodiment 4

The composite film or method of any of embodiments 1, 2 and 3, wherein the first transparent substrate comprises a polymer material, wherein the first substrate comprises a glass substrate; wherein the first substrate consists of a polymer material; wherein the first substrate consists of a glass substrate.

### Embodiment 5

The composite film or method of any of embodiments 1, 2 and 3, wherein the first transparent substrate comprises a PET, wherein the first transparent substrate consists of PET.

### Embodiment 6

The composite film or method of any of embodiments 1, 2 and 3, wherein the second transparent substrate comprises a polymer material, wherein the second substrate comprises a glass substrate; wherein the second substrate consists of a polymer material; wherein the second substrate consists of a glass substrate.

### Embodiment 7

The composite film or method of any of embodiments 1, 2 and 3, wherein the second transparent substrate comprises a PET, wherein the second transparent substrate consists of PET.

### Embodiment 8

The composite film or method of any of embodiments 1, 2 and 3, wherein the composite film comprises a VLT of at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85% and at least about 90%.

### Embodiment 9

The composite film or method of any of embodiments 1, 2 and 3, wherein the composite film comprises a VLT of not greater than about 95%.

### Embodiment 10

The composite film or method of any of the previous embodiments, wherein the composite film comprises a TSER of at least about 40%.

### Embodiment 11

The composite film or method of any of embodiments 1, 2 and 3, wherein the composite film comprises a TSER of not greater than about 85%.

### Embodiment 12

The composite film or method of any of embodiments 1, 2 and 3, wherein the functional layers consist essentially of silver.

### Embodiment 13

The composite film or method of any of the previous embodiments, wherein the blocker layers consist essentially of NiCr.

### Embodiment 14

The composite film or method of any of embodiments 1, 2 and 3, wherein the first functional layer has a thickness of at least about 5 nanometers, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers and at least about 20 nanometers.

### Embodiment 15

The composite film or method of any of embodiments 1, 2 and 3, wherein the first functional layer has a thickness of not greater than about 25 nanometers, not greater than about 24 nanometers, not greater than about 23 nanometers, not greater than about 22 nanometers, not greater than about 21 nanometers, not greater than about 20 nanometers, not greater than about 19 nanometers, not greater than about 18 nanometers, not greater than about 17 nanometers, not greater than about 16 nanometers and not greater than about 15 nanometers.

### Embodiment 16

The composite film or method of any of embodiments 1, 2 and 3, wherein the second functional layer has a thickness of at least about 5 nanometers, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers and at least about 20 nanometers.

### Embodiment 17

The composite film or method of any of embodiments 1, 2 and 3, wherein the second functional layer has a thickness of not greater than about 25 nanometers, not greater than about 24 nanometers, not greater than about 23 nanometers, not greater than about 22 nanometers, not greater than about 21 nanometers, not greater than about 20 nanometers, not greater than about 19 nanometers, not greater than about 18 nanometers, not greater than about 17 nanometers, not greater than about 16 nanometers and not greater than about 15 nanometers.

### Embodiment 18

The composite film or method of any of embodiments 1, 2 and 3, wherein the each of the blocker layers has a thickness of not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers and not greater than about 0.2 nanometers.

### Embodiment 19

The composite film or method of any of embodiments 1, 2 and 3, wherein the each of the blocker layers has a thickness of at least about 0.1 nanometers, at least about 0.2 nanometers, at least about 0.3 nanometers, at least about 0.4 nanometers.

### Embodiment 20

The composite film or method of any of embodiments 1, 2 and 3, wherein the dielectric layers comprise ITO, SnZnOₓ, SiOₓ, Si₃N₄, Nb₂Oₓ, TiOₓ, In₂Oₓ, ZnOₓ or AZO.

### Embodiment 21

The composite film or method of any of embodiments 1, 2 and 3, wherein the dielectric layers consist essentially of ITO, SnZnOₓ, SiOₓ, Si₃N₄, Nb₂Oₓ, TiOₓ, In₂Oₓ, ZnOₓ or AZO.

### Embodiment 22

The composite film or method of any of embodiments 1, 2 and 3, wherein the composite film comprises a Solar Control Ratio VLT/(100%-TSER) of at least about 0.5, such as, at least about 0.6, at least about 0.7, at least about 0.8, at least about 0.9, at least about 1.0, at least about 1.1, at least about 1.2, at least about 1.3, at least about 1.4 or even at least about 1.5.

### Embodiment 23

The composite film or method of any of embodiments 1, 2 and 3, wherein the composite film further comprises a thickness ratio TH_{BL1}/TH_{FL} of not greater than about 0.5, where TH_{BL1} is the average thickness of the blocker layers in the composite film and TH_{FL} is the average thickness of the functional layers in the composite film, not greater than about 0.45, not greater than about 0.4, not greater than about 0.35, not greater than about 0.3, not greater than about 0.25, not greater than about 0.2, not greater than about 0.15, not greater than about 0.1 and not greater than about 0.05.

### Embodiment 24

The composite film or method of any of embodiments 1, 2 and 3, wherein the composite film further comprises a thickness ratio TH_{BL1}/TH_{FL} of at least about 0.01, where TH_{BL1} is the average thickness of the blocker layers in the composite film and TH_{FL} is the average thickness of the functional layers in the composite film, at least about 0.02, at least about 0.03, at least about 0.04, at least about 0.05, at least about 0.06, at least about 0.07, at least about 0.08, at least about 0.09 and at least about 0.1.

### Embodiment 25

A composite window film comprising: a first transparent substrate; a dielectric layer; and at least two infra-red reflection stacks, wherein the dielectric layer is located between the at least two infra-red reflection stacks; and wherein each infra-red reflection stack comprises: two blocker layers comprising NiCr; and a functional layer comprising silver between the two blocker layers, and wherein the blocker layers each have a thickness of at least about 0.2 nm and not greater than about 5 nm.

### Embodiment 26

A composite window film comprising: a first transparent substrate; a first dielectric layer adjacent to the first transparent substrate layer; a first blocker layer comprising NiCr adjacent to the first dielectric layer; a first functional layer comprising silver adjacent to the first blocker layer; a second blocker layer comprising NiCr adjacent to the first functional layer; a second dielectric layer adjacent to the second blocker layer; a third blocker layer comprising NiCr adjacent to the second dielectric layer; a second functional layer comprising silver adjacent to the third blocker layer; a fourth blocker layer comprising NiCr adjacent to the second functional layer; a third dielectric layer adjacent to the fourth blocker layer; and a second transparent substrate adjacent to the third dielectric layer, wherein the blocker layers each have a thickness of at least about 0.2 nm and not greater than about 5 nm.

### Embodiment 27

A method of forming a composite window film, wherein the method comprises: providing a first transparent substrate; forming a first dielectric layer adjacent to the first dielectric layer; forming a first blocker layer comprising NiCr adjacent to the first transparent substrate layer; forming a first functional layer comprising silver adjacent to the first blocker layer; forming a second blocker layer comprising NiCr adjacent to the first functional layer; forming a second dielectric layer adjacent to the second blocker layer; forming a third blocker layer comprising NiCr adjacent to the second dielectric layer; forming a second functional layer comprising silver adjacent to the third blocker layer; forming a fourth blocker layer comprising NiCr adjacent to the second functional layer; forming a third dielectric layer adjacent to the fourth blocker layer; and providing a second transparent substrate adjacent to the third dielectric layer, wherein the blocker layers each have a thickness of at least about 0.2 nm and not greater than about 5 nm.

### Embodiment 28

The composite window film or method of any of embodiments 25, 26 and 27, wherein the first transparent substrate comprises a polymer material, wherein the first substrate comprises a glass substrate; wherein the first substrate consists of a polymer material; wherein the first substrate consists of a glass substrate.

### Embodiment 29

The composite window film or method of any of embodiments 25, 26 and 27, wherein the first transparent substrate comprises a PET, wherein the second transparent substrate consists of PET.

### Embodiment 30

The composite window film or method of any of embodiments 25, 26 and 27, wherein the second transparent substrate comprises a polymer material, wherein the second substrate comprises a glass substrate; wherein the second substrate consists of a polymer material; wherein the second substrate consists of a glass substrate.

### Embodiment 31

The composite film or method of any of embodiments 25, 26 and 27, wherein the second transparent substrate comprises a PET, wherein the second transparent substrate consists of PET.

### Embodiment 32

The composite window film or method of any of embodiments 25, 26 and 27, wherein the composite film comprises a VLT of at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85% and at least about 90%.

### Embodiment 33

The composite window film or method of any of embodiments 25, 26 and 27, wherein the composite film comprises a VLT of not greater than about 99%, not greater than about 95%, not greater than about 90%, not greater than about 85%, not greater than about 80%, not greater than about 75%, not greater than about 70%, not greater than about 65%, not greater than about 60%, not greater than about 55%, not greater than about 50%, not greater than about 45%, not greater than about 40%, not greater than about 35%, not greater than about 30%, not greater than about 25%, not greater than about 20% and not greater than about 15%.

### Embodiment 34

The composite window film or method of any of embodiments 25, 26 and 27, wherein the composite film comprises a TSER of at least about 50%, at least about 55%, at least about 60%, at least about 65%, at least about 70% and at least about 75%.

### Embodiment 35

The composite window film or method of any of embodiments 25, 26 and 27, wherein the composite film comprises a TSER of not greater than about 80%, not greater than about 75%, not greater than about 70%, not greater than about 65%, not greater than about 60% and not greater than about 55%.

### Embodiment 36

The composite window film or method of any of embodiments 25, 26 and 27, wherein the functional layers consist essentially of silver.

### Embodiment 37

The composite window film or method of any of embodiments 25, 26 and 27, wherein the blocker layers consist essentially of NiCr.

### Embodiment 38

The composite window film or method of any of embodiments 25, 26 and 27, wherein the first functional layer has a thickness of at least about 5 nanometers, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers and at least about 20 nanometers.

### Embodiment 39

The composite window film or method of any of embodiments 25, 26 and 27, wherein the first functional layer has a thickness of not greater than about 25 nanometers, not greater than about 24 nanometers, not greater than about 23 nanometers, not greater than about 22 nanometers, not greater than about 21 nanometers, not greater than about 20 nanometers, not greater than about 19 nanometers, not greater than about 18 nanometers, not greater than about 17 nanometers, not greater than about 16 nanometers an not greater than about 15 nanometers.

### Embodiment 40

The composite window film or method of any of embodiments 25, 26 and 27, wherein the second functional layer has a thickness of at least about 5 nanometers, at least about 6 nanometers, at least about 7 nanometers, at least about 8 nanometers, at least about 9 nanometers, at least about 10 nanometers, at least about 12 nanometers, at least about 14 nanometers, at least about 16 nanometers, at least about 18 nanometers and at least about 20 nanometers.

### Embodiment 41

The composite window film or method of any of embodiments 25, 26 and 27, wherein the second functional layer has a thickness of not greater than about 25 nanometers, not greater than about 24 nanometers, not greater than about 23 nanometers, not greater than about 22 nanometers, not greater than about 21 nanometers, not greater than about 20 nanometers, not greater than about 19 nanometers, not greater than about 18 nanometers, not greater than about 17 nanometers, not greater than about 16 nanometers an not greater than about 15 nanometers.

### Embodiment 42

The composite window film or method of any of embodiments 25, 26 and 27, wherein the each of the blocker layers has a thickness of not greater than about 5 nanometers, not greater than about 4.5 nanometers, not greater than about 4 nanometers, not greater than about 3.5 nanometers, not greater than about 3 nanometers, not greater than about 2.8 nanometers, not greater than about 2.6 nanometers, not greater than about 2.4 nanometers, not greater than about 2.2 nanometers, not greater than about 2.0 nanometers, not greater than about 1.8 nanometers, not greater than about 1.6 nanometers, not greater than about 1.4 nanometers, not greater than about 1.2 nanometers, not greater than about 1.0 nanometers, not greater than about 0.8 nanometers, not greater than about 0.6 nanometers, not greater than about 0.5 nanometers, not greater than about 0.4 nanometers, not greater than about 0.3 nanometers and not greater than about 0.2 nanometers.

### Embodiment 43

The composite window film or method of any of embodiments 25, 26 and 27, wherein the each of the blocker layers has a thickness of at least about 0.1 nanometers, at least about 0.2 nanometers, at least about 0.3 nanometers, at least about 0.4 nanometers.

### Embodiment 44

The composite window film or method of any of embodiments 25, 26 and 27, wherein the dielectric layers comprise ITO, SnZnOₓ, SiOₓ, Si₃N₄, Nb₂Oₓ, TiOₓ, In₂Oₓ, ZnOₓ or AZO.

### Embodiment 45

The composite window film or method of any of embodiments 25, 26 and 27, wherein the dielectric layers consists essentially of ITO, SnZnOₓ, SiOₓ, Si₃N₄, Nb₂Oₓ, TiOₓ, In₂Oₓ, ZnOₓ or AZO.

### Embodiment 46

The composite window film or method of any of embodiments 25, 26 and 27, wherein the composite film comprises a Solar Control Ratio VLT/(100%-TSER) of at least about 0.5, such as, at least about 0.6, at least about 0.7, at least about 0.8, at least about 0.9, at least about 1.0, at least about 1.1, at least about 1.2, at least about 1.3, at least about 1.4 or even at least about 1.5.

### Embodiment 47

The composite window film or method of any of embodiments 25, 26 and 27, wherein the composite film further comprises a thickness ratio TH_{BL1}/TH_{FL} of not greater than about 0.5, where TH_{BL1} is the average thickness of the blocker layers in the composite film and TH_{FL} is the average thickness of the functional layers in the composite film, not greater than about 0.45, not greater than about 0.4, not greater than about 0.35, not greater than about 0.3, not greater than about 0.25, not greater than about 0.2, not greater than about 0.15, not greater than about 0.1 and not greater than about 0.05.

### Embodiment 48

The composite window film or method of any of embodiments 25, 26 and 27, wherein the composite film further comprises a thickness ratio TH_{BL1}/TH_{FL} of at least about 0.01, where TH_{BL1} is the average thickness of the blocker layers in the composite film and TH_{FL} is the average thickness of the functional layers in the composite film, at least about 0.02, at least about 0.03, at least about 0.04, at least about 0.05, at least about 0.06, at least about 0.07, at least about 0.08, at least about 0.09 and at least about 0.1.

### Embodiment 49

A composite window film configured for application on a sunroof, wherein the window film comprises: a first transparent substrate; a dielectric layer; and at least two infra-red reflection stacks, wherein the dielectric layer is located between the at least two infra-red reflection stacks; and wherein each infra-red reflection stack comprises: two blocker layers comprising NiCr; and a functional layer comprising silver between the two blocker layers, and wherein the blocker layers each have a thickness of at least about 1 nm and not greater than about 5 nm.

### Embodiment 50

A composite window film configured for application on a sunroof, wherein the window film comprises: a first transparent substrate; a first dielectric layer adjacent to the first transparent substrate layer; a first blocker layer comprising NiCr adjacent to the first dielectric layer; a first functional layer comprising silver adjacent to the first blocker layer; a second blocker layer comprising NiCr adjacent to the first functional layer; a second dielectric layer adjacent to the second blocker layer; a third blocker layer comprising NiCr adjacent to the second dielectric layer; a second functional layer comprising silver adjacent to the third blocker layer; a fourth blocker layer comprising NiCr adjacent to the second functional layer; a third dielectric layer adjacent to the fourth blocker layer; and a second transparent substrate adjacent to the third dielectric layer, wherein the blocker layers each have a thickness of at least about 1 nm and not greater than about 5 nm.

### Embodiment 51

A composite window film configured for application on a sunroof, wherein the window film comprises: providing a first transparent substrate; forming a first dielectric layer adjacent to the first transparent substrate layer; forming a first blocker layer comprising NiCr adjacent to the first dielectric layer; forming a first functional layer comprising silver adjacent to the first blocker layer; forming a second blocker layer comprising NiCr adjacent to the first functional layer; forming a second dielectric layer adjacent to the second blocker layer; forming a third blocker layer comprising NiCr adjacent to the second dielectric layer; forming a second functional layer comprising silver adjacent to the third blocker layer; forming a fourth blocker layer comprising NiCr adjacent to the second functional layer; forming a third dielectric layer adjacent to the fourth blocker layer; and providing a second transparent substrate adjacent to the third dielectric layer, wherein the blocker layers each have a thickness of at least about 1 nm and not greater than about 5 nm.

### Embodiment 52

The composite window film or method of any of embodiments 49, 50 and 51, wherein the first transparent substrate comprises a polymer material, wherein the first substrate comprises a glass substrate; wherein the first substrate consists of a polymer material; wherein the first substrate consists of a glass substrate.

### Embodiment 53

The composite window film or method of any of embodiments 49, 50 and 51, wherein the first transparent substrate comprises a PET, wherein the second transparent substrate consists of PET.

### Embodiment 54

The composite window film or method of any of embodiments 49, 50 and 51, wherein the second transparent substrate comprises a polymer material, wherein the second substrate comprises a glass substrate; wherein the second substrate consists of a polymer material; wherein the second substrate consists of a glass substrate.

### Embodiment 55

The composite window film or method of any of embodiments 49, 50 and 51, wherein the second transparent substrate comprises a PET, wherein the second transparent substrate consists of PET.

### Embodiment 56

The composite window film or method of any of embodiments 49, 50 and 51, wherein the composite film comprises a VLT of at least about 10%, at least about 15%, at least about 20%, at least about 25%, at least about 30%, at least about 35%, at least about 40%, at least about 45%, at least about 50%.

### Embodiment 57

The composite window film or method of any of embodiments 49, 50 and 51, wherein the composite film comprises a VLT of not greater than about 65%, not greater than about 60%, not greater than about 55%, not greater than about 50%, not greater than about 45%, not greater than about 40%, not greater than about 35%, not greater than about 30%, not greater than about 25%, not greater than about 20% and not greater than about 15%.

### Embodiment 58

The composite window film or method of any of embodiments 49, 50 and 51, wherein the composite film comprises a TSER of at least about 40%, at least about 45%, at least about 50%, at least about 55%.

### Embodiment 59

The composite window film or method of any of embodiments 49, 50 and 51, wherein the composite film comprises a TSER of not greater than about 80%, not greater than about 75%, not greater than about 70%, not greater than about 65%, not greater than about 60% and not greater than about 55%.

### Embodiment 60

The composite window film or method of any of embodiments 49, 50 and 51, wherein the functional layers consist essentially of silver.

### Embodiment 61

The composite window film or method of any of embodiments 49, 50 and 51, wherein the blocker layers consist essentially of NiCr.

### Embodiment 62

The composite window film or method of any of embodiments 49, 50 and 51, wherein the first functional layer has a thickness of at least about 8 nanometers, at least about 9 nanometers, at least about 10 nanometers, at least about 11 nanometers and at least about 12 nanometers.

### Embodiment 63

The composite window film or method of any of embodiments 49, 50 and 51, wherein the first functional layer has a thickness of not greater than about 13 nanometers, not greater than about 12 nanometers and not greater than about 11 nanometers.

### Embodiment 64

The composite window film or method of any of embodiments 49, 50 and 51, wherein the second functional layer has a thickness of at least about 8 nanometers, at least about 9 nanometers, at least about 10 nanometers, at least about 11 nanometers and at least about 12 nanometers.

### Embodiment 65

The composite window film or method of any of embodiments 49, 50 and 51, wherein the second functional layer has a thickness of not greater than about 13 nanometers, not greater than about 12 nanometers and not greater than about 11 nanometers.

### Embodiment 66

The composite window film or method of any of embodiments 49, 50 and 51, wherein the each of the blocker layers has a thickness of not greater than about 2.0 nanometers, not greater than about 1.8 nanometers, not greater than about 1.6 nanometers, not greater than about 1.4 nanometers.

### Embodiment 67

The composite window film or method of any of embodiments 49, 50 and 51, wherein the each of the blocker layers has a thickness of at least about 1.0 nanometers, at least about 1.1 nanometers, at least about 1.2 nanometers, at least about 1.3 nanometers and at least about 1.4 nanometers.

### Embodiment 68

The composite window film or method of any of embodiments 49, 50 and 51, wherein the dielectric layers comprise ITO, SnZnOₓ, SiOₓ, Si₃N₄, Nb₂Oₓ, TiOₓ, In₂Oₓ, ZnOₓ or AZO.

### Embodiment 69

The composite window film or method of any of embodiments 49, 50 and 51, wherein the dielectric layers consists essentially of ITO, SnZnOₓ, SiOₓ, Si₃N₄, Nb₂Oₓ, TiOₓ, In₂Oₓ, ZnOₓ or AZO.

### Embodiment 70

The composite window film or method of any of embodiments 49, 50 and 51, wherein the composite film comprises a Solar Control Ratio VLT/(100%-TSER) of at least about 0.5, such as, at least about 0.6, at least about 0.7, at least about 0.8, at least about 0.9, at least about 1.0, at least about 1.1, at least about 1.2, at least about 1.3, at least about 1.4 and at least about 1.5.

### Embodiment 71

The composite window film or method of any of embodiments 49, 50 and 51, wherein the composite film further comprises a thickness ratio TH_{BL1}/TH_{FL} of not greater than about 0.25, where TH_{BL1} is the average thickness of the blocker layers in the composite film and TH_{FL} is the average thickness of the functional layers in the composite film, not greater than about 0.2, not greater than about 0.15, not greater than about 0.1 and not greater than about 0.08.

### Embodiment 72

The composite window film or method of any of embodiments 49, 50 and 51, wherein the composite film further comprises a thickness ratio TH_{BL1}/TH_{FL} of at least about 0.05, where TH_{BL1} is the average thickness of the blocker layers in the composite film and TH_{FL} is the average thickness of the functional layers in the composite film, at least about 0.02, at least about 0.03, at least about 0.04, at least about 0.05, at least about 0.06, at least about 0.07, at least about 0.08, at least about 0.09 and at least about 0.1.

### EXAMPLES

The concepts described herein will be further described in the following Examples, which do not limit the scope of the invention described in the claims.

### Example 1

Fourteen sample composite window films S1-S14 were configured and formed according to certain embodiments described herein. All fourteen sample composite window films S1-S14 include a first transparent PET substrate (i.e., bottom), a first infra-red reflection stack having a silver functional layer between two NiCr blocker layer, a second infra-red reflection stack having a silver functional layer between two NiCr blockers layers, three TiOₓ dielectric layers and a second transparent PET substrate (i.e., top). The configuration of layers in each composite window film, including general layer composition, arrangement and thickness, are summarized below in Table 1. It will be appreciated that the order of the layers listed in Table 1 indicates the order of the layers in the composite window film with the bottom row in the table corresponding to the bottom layer in the composite window film.

TABLE 1
Sample Composite Window Film Configurations

| | S1 | S2 | S3 | S4 | S5 | S6 | S7 | S8 | S9 | S10 | S11 | S12 | S13 | S14 |
|---|---|---|---|---|---|---|---|---|---|---|---|---|---|---|
| PET | 25 | 25 | 25 | 25 | 25 | 25 | 25 | 25 | 25 | 25 | 25 | 25 | 25 | 25 |
| SUB. (μm) | | | | | | | | | | | | | | |
| TiOx (nm) | 30 | 30 | 30 | 30 | 30 | 30 | 30 | 30 | 30 | 30 | 30 | 30 | 30 | 30 |
| NiCr (nm) | 1 | 1 | 1.5 | 2 | 1 | 2.5 | 3 | 3.5 | 3 | 3 | 4 | 2 | 1 | 5 |
| Ag (nm) | 10 | 13 | 10 | 10 | 15 | 10 | 10 | 10 | 13 | 15 | 10 | 13 | 13 | 10 |
| NiCr (nm) | 1 | 1 | 1.5 | 2 | 1 | 2.5 | 3 | 3.5 | 3 | 3 | 4 | 2 | 1 | 5 |
| TiOx (nm) | 60 | 60 | 60 | 60 | 60 | 60 | 60 | 60 | 60 | 60 | 60 | 60 | 60 | 60 |
| NiCr (nm) | 1 | 1 | 1.5 | 2 | 1 | 2.5 | 3 | 3.5 | 3 | 3 | 4 | 2 | 1 | 5 |
| Ag (nm) | 10 | 13 | 10 | 10 | 15 | 10 | 10 | 10 | 13 | 15 | 10 | 13 | 13 | 10 |
| NiCr (nm) | 1 | 1 | 1.5 | 2 | 1 | 2.5 | 3 | 3.5 | 3 | 3 | 4 | 2 | 1 | 5 |
| TiOx (nm) | 30 | 30 | 30 | 30 | 30 | 30 | 30 | 30 | 30 | 30 | 30 | 30 | 30 | 30 |
| PET | 50 | 50 | 50 | 50 | 50 | 50 | 50 | 50 | 50 | 50 | 50 | 50 | 50 | 50 |
| SUB. (μm) | | | | | | | | | | | | | | |

Optical properties of each sample composite window film are summarized in Table 2 below. The summarized optical properties include: VLT, VLR TSER, LSHGC, Transmission, and Reflection measured according to ISO 9050 using a Perkin Elmer Lambda 900 spectrophotometer.

TABLE 2
Sample Composite Window Film Optical Property Measurements

| OPT. PROP. | S1 | S2 | S3 | S4 | S5 | S6 | S7 | S8 | S9 | S10 | S11 | S12 | S13 | S14 |
|---|---|---|---|---|---|---|---|---|---|---|---|---|---|---|
| VLT (%) | 54.8 | 51.3 | 40.5 | 33.6 | 48.0 | 32.5 | 27.6 | 20.0 | 22.4 | 20.4 | 18.8 | 34.3 | 50.2 | 12.1 |
| VLR1 (%) | 9.7 | 10.9 | 8.5 | 8.6 | 10.6 | 10.0 | 10.5 | 9.9 | 10.9 | 12.5 | 11.7 | 10.4 | 9.9 | 13.0 |
| VLR2 (%) | 10.7 | 12.2 | 9.9 | 10.3 | 12.0 | 12.1 | 13.2 | 14.7 | 14.4 | 15.4 | 16.5 | 13.1 | 11.3 | 17.7 |
| TSER (%) | 57.2 | 64.6 | 64.4 | 67.8 | 69.1 | 68.5 | 71.1 | 74.2 | 76.0 | 78.6 | 75.2 | 71.5 | 65.5 | 78.1 |
| LSHGC | 1.28 | 1.45 | 1.14 | 1.04 | 1.55 | 1.03 | 0.96 | 0.77 | 0.93 | 0.95 | 0.76 | 1.20 | 1.45 | 0.55 |

Four comparative sample composite window films CS1-CS4 were configured and formed. Each comparative sample composite window film CS1-CS4 includes the following configuration: PET/TiOx 26/Au 1/Ag 12/Au 1/TiOx 60/Au 1/Ag 12/Au 1/TiOx 26. The TiOx 26 layer has a thickness of 26 microns. The TiOx 60 layer has a thickness of 60 microns. The Au 1 layer has a thickness of 1 micron. The Ag 12 layer has a thickness of 12 microns. Each comparative sample composite window film CS1-CS4 is then laminated with a counter-PET which is tinted with various intensities to achieve a desirable VLT. Since this tinted PET absorbs a lot of light before sunlight is reflected by Ag-based layers, it is less selective than continuously absorbing light through the thin film stacks with NiCr layers.

Optical properties of each comparative sample composite window film CS1-CS4 are summarized in Table 3 below. The summarized optical properties include: VLT, VLR TSER, LSHGC, Transmission, and Reflection measured according to ISO 9050 using a Perkin Elmer Lambda 900 spectrophotometer.

TABLE 3
Comparative Sample Composite Window Film Optical Property
Measurements

| OPT. | | | | |
|---|---|---|---|---|
| PROP. | CS1 | CS2 | CS3 | CS4 |
| VLT | 59 | 42 | 23 | 12 |
| (%) | | | | |
| VLR | 8 | 7 | 6 | 6 |
| (%) | | | | |
| TSER | 56 | 60 | 65 | 65 |
| (%) | | | | |
| LSHGC | 1.34 | 1.05 | 0.66 | 0.34 |

It should be noted that while varying the intensity of the tint allows some selectivity with regard to optical properties, the sample composite window films S1-S14 show more selectivity with regard to optical properties, especially VLT. Without wishing to be tied to any particular theory, it is believed that since this tinted PET absorbs a significant amount of light before it is reflected by Ag-based layers of the composite film, the film as a whole is less selective than continuously absorbing light through the thin film stacks with NiCr layers formed according to embodiments described herein.

### Example 2

A composite window film S15 formed for application on a sunroof was configured and formed according to certain embodiments described herein. The sample composite window film S15 includes a first transparent PET substrate (i.e., bottom), a first infra-red reflection stack having a silver functional layer between two NiCr blocker layer, a second infra-red reflection stack having a silver functional layer between two NiCr blockers layers and three TiOₓ dielectric layers. The configuration of layers of the sample composite window film S15, including general layer composition, arrangement and thickness, are summarized below in Table 4. It will be appreciated that the order of the layers listed in Table 4 indicates the order of the layers in the composite window film with the bottom row in the table corresponding to the bottom layer in the composite window film.

TABLE 4
Sample Composite Window Film Configuration

| | S15 |
|---|---|
| TiOx (nm) | 30 |
| NiCr (nm) | 1.5 |
| Ag (nm) | 10 |
| NiCr (nm) | 1.5 |
| TiOx (nm) | 65 |
| NiCr (nm) | 1.5 |
| Ag (nm) | 10 |
| NiCr (nm) | 1.5 |
| TiOx (nm) | 30 |
| PET SUB. (μm) | 50 |

The sample composite window film S15 was laminated with clear glass, two clear PVB layers and dark glass in the following configuration: CLR GLASS/CLEAR PVB (0.38 mm)/S15/CLEAR PVB (0.38 mm)/DARK GLASS.

A comparative sample window film CS2 was formed for comparison to the sample composite window film S15. The comparative sample window film CS2 was laminated with clear glass, a clear PVB layer, a tinted PVB layer and dark glass in the following configuration: CLR GLASS/CLEAR PVB (0.38 mm)/CS2/TINTED PVB (0.38 mm)/DARK GLASS.

Optical properties of the sample composite window film S15 and the comparative window film CS2 are summarized in Table 5 below. The summarized optical properties include: VLT, VLR TSER LSHGC, Transmission, and Reflection measured according to ISO 9050 using a Perkin Elmer Lambda 900 spectrophotometer.

TABLE 5
Window Film Optical Property Measurements

| | CS2 | S15 |
|---|---|---|
| VLT (%) | 7.6 | 12.3 |
| VLR1 (%) | 8.94 | 5.7 |
| VLR2 (%) | 4.7 | 4.9 |
| VLA (%) | 83.4 | 82.0 |
| TSER (%) | 78.4 | 76.3 |
| LSHGC | 0.36 | 0.52 |
| TTS (%) | 21.6 | 23.7 |
| a*T | −3.92 | −5.3 |
| b*T | −0.64 | −4.5 |
| a*R1 | −4 | 1.6 |
| b*R1 | −7.05 | −6.4 |
| a*R2 | −0.05 | 0.9 |
| b*R2 | −1.03 | −1.9 |

The foregoing embodiments represent a departure from the state-of-the-art. Notably, the composite safety stacks of the embodiments herein include a combination of features not previously recognized in the art and facilitate performance improvements. Such features can include, but are not limited to, particular configurations of layers within the composite stacks, including the use of a dual NiCr blocker structures or stacks. The composite stack embodiments described herein have demonstrated remarkable and unexpected improvements over state-of-the-art composite stacks. In particular, they have shown superior optical performance qualities, including high VLT and low TSER characteristics.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite film comprising:
a first transparent substrate;
a dielectric layer; and
at least two infra-red reflection stacks,
wherein the dielectric layer is located between the at least two infra-red reflection stacks; and
wherein each infra-red reflection stack comprises:
two blocker layers comprising NiCr; and
a functional layer comprising silver between the two blocker layers.

2. The composite film of claim 1, wherein the first transparent substrate comprises a polymer material.

3. The composite film of claim 1, wherein the first transparent substrate comprises a PET.

4. The composite film of claim 1, wherein the composite film comprises a VLT of at least about 10%.

5. The composite film of claim 1, wherein the composite film comprises a VLT of not greater than about 95%.

6. The composite film of claim 1, wherein the composite film comprises a TSER of at least about 40%.

7. The composite film of claim 1, wherein the composite film comprises a TSER of not greater than about 85%.

8. The composite film of claim 1, wherein the functional layers consist essentially of silver.

9. The composite film of claim 1, wherein the blocker layers consist essentially of NiCr.

10. The composite film of claim 1, wherein the first functional layer has a thickness of at least about 5 nanometers and not greater than about 25 nanometers.

11. The composite film of claim 1, wherein the second functional layer has a thickness of at least about 5 nanometers and not greater than about 25 nanometers.

12. The composite film of claim 1, wherein the each of the blocker layers has a thickness of not greater than about 5 nanometers and at least about 0.1 nanometers.

13. The composite film of claim 1, wherein the dielectric layers comprise ITO, SnZnOₓ, SiOₓ, Si₃N₄, Nb₂Oₓ, TiOₓ, In₂Oₓ, ZnOₓ or AZO.

14. A composite film comprising:
a first transparent substrate;
a first dielectric layer adjacent to the first transparent substrate layer;
a first blocker layer comprising NiCr adjacent to the first dielectric layer;
a first functional layer comprising silver adjacent to the first blocker layer;
a second blocker layer comprising NiCr adjacent to the first functional layer;
a second dielectric layer adjacent to the second blocker layer;
a third blocker layer comprising NiCr adjacent to the second dielectric layer;
a second functional layer comprising silver adjacent to the third blocker layer;
a fourth blocker layer comprising NiCr adjacent to the second functional layer;
a third dielectric layer adjacent to the fourth blocker layer; and
a second transparent substrate overlying the third dielectric layer.

15. The composite film of claim 14, wherein the composite film comprises a VLT of at least about 10%.

16. The composite film of claim 14, wherein the composite film comprises a VLT of not greater than about 95%.

17. The composite film of claim 14, wherein the composite film comprises a TSER of at least about 40%.

18. The composite film of claim 14, wherein the composite film comprises a TSER of not greater than about 85%.

19. The composite film of claim 14, wherein the functional layers consist essentially of silver.

20. A method of forming composite film, wherein the method comprises:
providing a first transparent substrate;
forming a first dielectric layer adjacent to the first transparent substrate layer;
forming a first blocker layer comprising NiCr adjacent to the first dielectric layer;
forming a first functional layer comprising silver adjacent to the first blocker layer;
forming a second blocker layer comprising NiCr adjacent to the first functional layer;
forming a second dielectric layer adjacent to the second blocker layer;
forming a third blocker layer comprising NiCr adjacent to the second dielectric layer;
forming a second functional layer comprising silver adjacent to the third blocker layer;
forming a fourth blocker layer comprising NiCr adjacent to the second functional layer;
forming a third dielectric layer adjacent to the fourth blocker layer; and
providing a second transparent substrate overlying the third dielectric layer.
